(19) United States
(12) Patent Application Publication
(10) Pub. No.: US 2026/0337438 A1
(43) Pub. Date: Oct. 29, 2026

(54) COATING COMPOSITIONS INCLUDING AN ACRYLIC POLYMER AND A PHENOLIC CROSSLINKER, ARTICLES, ACRYLIC POLYMERS, AND METHODS

(71) Applicant: SWIMC LLC, Cleveland, OH (US)

(72) Inventors: Yingchao ZHANG, Murrysville, PA (US); Nusrah HUSSAIN, Gibsonia, PA (US); Danielle METZGER, Valencia, PA (US); Daniel DEMARCHI, Pittsburgh, PA (US)

(21) Appl. No.: 19/106,815

(22) PCT Filed: Aug. 31, 2023
(86) PCT No.: PCT/US2023/031747

§ 371 Date: Feb. 26, 2025

Related U.S. Application Data
(60) Provisional application No. 63/402,869, filed on Aug. 31, 2022.

(51) Int. Cl. C09D 125/14; B65D 25/14

(52) U.S. Cl. CPC C09D 125/14; B65D 25/14

(57) ABSTRACT

An aqueous food or beverage container coating composition, acrylic polymer, coated article (e.g., coated metal substrate and metal packaging formed from such substrate), and methods (e.g., method of making a coating composition and method coating such composition), wherein the coating composition includes: at least 5 wt-%, based on total resin solids, of an acrylic polymer; a phenolic crosslinker; and an aqueous liquid carrier.

### CROSS-REFERENCE TO RELATED APPLICATIONS

This application claims the benefit of U.S. Provisional Application No. 63/402,869, filed 31 Aug. 2022, the disclosure of which is incorporated by reference herein in its entirety.

### BACKGROUND

Various coatings have been used as interior protective container coatings, including, for example, aromatic polyesters (based on terephthalic acid). In general, it is difficult to take such polymers, which have utility in solvent-based coating compositions, and successfully disperse them into an aqueous medium to produce a storage stable water-based coating composition that exhibits suitable coating properties when cured. This is especially true in the area of packaging coatings (e.g., food or beverage container coatings), where coating compositions must exhibit a stringent balance of difficult to achieve coating properties. To address this shortcoming, the packaging coatings industry has sought alternative coatings.

The balance of coating performance attributes required for a coating composition to be suitable for use as a food or beverage container coating are particularly stringent and are unique from other coating end uses. As such, coatings designed for other end uses are not typically suitable for use as food or beverage container coatings.

For example, coatings for use on food or beverage containers should avoid unsuitably altering the taste of the packaged food or beverage products, and should also avoid flaking or chipping into the packaged products. The coatings should also resist chemically aggressive food or beverage products (which can have a complex chemical profile, including salts, acids, sugars, fats, etc.) for extended periods of time (e.g., years). Food or beverage container coatings should also have good adhesion to the underlying substrate (e.g., metal substrate) and remain sufficiently flexible after curing. This is because subsequent fabrication and denting during transportation, storage, or use (e.g., by dropping) may cause the metal substrate to deform, which will cause the coating to flex. A brittle coating will crack during flexure, exposing the container metal to the packaged products, which can sometimes cause a leak in the container. Even a low probability of coating failure may cause a significant number of containers to leak, given the high number of food and beverage containers produced.

Various coatings have been used as protective food or beverage container coatings, including epoxy coatings and polyvinyl-chloride-based coatings. Each of these coating types, however, has potential shortcomings. For example, the recycling of materials containing polyvinyl chloride or related halide-containing vinyl polymers can be problematic. There is also a desire by some to reduce or eliminate certain epoxy compounds (e.g., bisphenol A) commonly used to formulate food-contact epoxy coatings. Although a number of replacement coating compositions made without such materials have been proposed, some replacement compositions have exhibited insufficient coating properties such as insufficient storage stability, insufficient corrosion resistance on metal substrates, insufficient flexibility, or insufficient toughness.

To address the aforementioned shortcomings, the packaging coatings industry has sought coatings based on alternative binder systems such as polyester resin systems, for example. It has been problematic, however, to formulate polyester-based coatings that exhibit the required balance of coating characteristics (e.g., flexibility, adhesion, corrosion resistance, stability, resistance to crazing, etc.). For example, there has typically been a tradeoff between corrosion resistance and fabrication properties for such coatings. Polyester-based coatings suitable for food contact that have exhibited both good fabrication properties and an absence of crazing, have tended to be too soft and exhibit unsuitable corrosion resistance. Conversely, polyester-based coatings suitable for food contact that have exhibited good corrosion resistance have typically exhibited poor flexibility and unsuitable crazing when fabricated.

Accordingly, it will be appreciated that what is needed in the art are improved coating compositions that exhibit the stringent balance of coating properties to permit the use of such coating compositions on food or beverage containers.

### SUMMARY OF THE DISCLOSURE

The present disclosure provides aqueous food or beverage container coating compositions, articles having a coating formed from such compositions (e.g., coated metal substrates and metal packaging formed from such substrates), and methods (e.g., methods of making a coating composition and methods of coating such composition).

The aqueous food or beverage container coating compositions (preferably, food container coating compositions) described herein include: an acid- or anhydride functional acrylic polymer, preferably at least 50 weight percent (wt-%), based on total resin solids, of the acid- or anhydride functional acrylic polymer, and preferably the acid- or anhydride functional polymer is at least partially neutralized; a phenolic crosslinker; and an aqueous liquid carrier. The present disclosure also provides an at least partially neutralized acid- or anhydride-functional acrylic polymer.

The present disclosure also provides acrylic polymers. In one embodiment, an acid- or anhydride-functional organic-solution polymerized acrylic polymer, preferably an at least partially neutralized acid- or anhydride-functional organic-solution polymerized acrylic polymer, as described herein for use in an aqueous coating composition, is provided. In a preferred embodiment, an at least partially neutralized acid- or anhydride-functional organic-solution polymerized acrylic polymer is provided that includes interpolymerized monomers including (meth)acrylic acid monomers, wherein the acrylic polymer is hydroxyl-functional, has a calculated acid number of less than 60 mg KOH per gram resin, and is self-dispersible in water. Furthermore, in this embodiment, the acrylic polymer is crosslinked with at least 5 wt-% resole phenolic crosslinker, based on total resin solids.

The present disclosure also provides coated metal substrates and metal packaging formed from such coated metal substrates. In one embodiment, a coated metal substrate is provided that includes a metal substrate having a cured adherent coating disposed on at least a portion of a surface thereof, wherein the coating is formed from an aqueous coating composition described herein. In a preferred embodiment, a coated metal substrate is provided that includes a metal substrate having a cured adherent coating disposed on at least a portion of a surface thereof, wherein the coating is formed from an aqueous food container coating composition including: at least 50 wt-%, based on total resin solids, of an at least partially neutralized acid- or anhydride-functional organic-solution polymerized acrylic polymer; at least 5 wt-%, preferably at least 20 wt-%, of crosslinker including one or more phenolic crosslinkers, based on total resin solids; and an aqueous liquid carrier. In this embodiment, the acrylic polymer is hydroxyl-functional, has a calculated acid number of less than 60 mg KOH per gram resin, and is self-dispersible in water.

The present disclosure also provides methods. In one embodiment, a method of forming an aqueous food or beverage coating composition (preferably, an aqueous food container coating composition) as described herein is provided, wherein the method includes: polymerizing an ethylenically unsaturated monomer component in organic solvent to form an acid- or anhydride-functional acrylic polymer having a calculated acid number of less than 60 mg KOH per gram polymer; preferably, at least partially neutralizing the acid- or anhydride-functional acrylic polymer with a fugitive base; forming a mixture of the acid- or anhydride functional polymer or the at least partially neutralized acid- or anhydride-functional acrylic polymer with a phenolic crosslinker; and combining the mixture with water to form an aqueous coating composition that includes (i) at least 50 wt-%, based on total resin solids, of the acrylic polymer and (ii) at least 5 wt-%, based on total resin solids, of the phenolic crosslinker; wherein the aqueous coating composition is storage stable for at least 2 months, at ambient temperature, not in direct sunlight, without any phase separation as determined by the unaided human eye.

In one embodiment, a method of coating a food or beverage container is provided (preferably, a food container), wherein the method includes: providing an aqueous food or beverage container coating composition as described herein; causing the coating composition to be applied to at least a portion of a metal substrate prior to or after forming the metal substrate into a food or beverage container or portion thereof; and thermally curing the coating composition to form a cured coating.

Herein, “metal packaging” refers to a food or beverage container (e.g., can or cup), portion thereof, or metal closure, or pull tab for an easy open end. A food or beverage “container” is used to encompass containers such as pails or drums in addition to conventional cans and cups.

The term “food-contact surface” refers to a surface of an article (e.g., a food can) intended for prolonged contact with a food product. The term “beverage-contact surface” refers to a surface of an article (e.g., a beverage can) intended for prolonged contact with a beverage product. When used, for example, in the context of a metal substrate of a container (e.g., food or beverage can), the terms “food contact surface” and “beverage contact surface” generally refers to an interior metal surface of the container that would be expected to contact the food/beverage product in the absence of a coating composition applied thereon. By way of example, a base layer, intermediate layer, and/or top-coat layer applied on an interior surface of a metal food/beverage can is considered to be applied on a food-contact/beverage-contact surface of the can.

The term “on,” when used in the context of a coating applied on a surface or substrate, includes both coatings applied directly (e.g., virgin metal or pre-treated metal such as electroplated steel) or indirectly (e.g., on a primer layer) to the surface or substrate. Thus, for example, a coating applied to a pre-treatment layer (e.g., formed from a chrome or chrome-free pretreatment) or a primer layer overlying a substrate constitutes a coating applied on (or disposed on) the substrate.

A “cured” coating refers to one wherein the polymer is covalently cured via a crosslinking reaction (e.g., a thermoset coating), and adhered to a metal substrate, thereby forming a coated metal substrate.

An “adherent” coating refers to a cured coating that adheres (i.e., is fixed) to a substrate, such as a metal substrate, preferably according to the Adhesion Test described in the Test Methods (ASTM D3359-17). Preferably, an adhesion rating of at least 4B is considered to be adherent.

The term “substantially free” of a particular component means that the compositions or cured coatings of the present disclosure contain less than 1,000 parts per million (ppm) of the recited component, if any. The term “essentially free” of a particular component means that the compositions or cured coatings of the present disclosure contain less than 100 parts per million (ppm) of the recited component, if any. The term “essentially completely free” of a particular component means that the compositions or cured coatings of the present disclosure contain less than 10 parts per million (ppm) of the recited component, if any. The term “completely free” of a particular component means that the compositions or cured coatings of the present disclosure contain less than 20 parts per billion (ppb) of the recited component, if any. The preceding terms of this paragraph when used with respect to a composition or cured coating that may contain a recited component, if any, means that the composition or cured coating contains less than the pertinent ppm or ppb maximum threshold for the component regardless of the context of the component in the composition or cured coating (e.g., regardless of whether the compound is present in unreacted form, in reacted form as a structural unit of another material, or a combination thereof).

The phrase “total resin solids” refers to the nonvolatile organic content of the coating composition, which includes the polymer solids content of the resin as well as other nonvolatile organic additives, e.g., lubricants (but not organic solvent). This can be determined using the test procedure described herein when no inorganic materials (e.g., fillers or pigments) are present. If inorganic materials are present, the total resin solids can be calculated based on the starting materials. If a calculation is not possible due to lack of information, inorganic material and water and organic solvent content can be determined using Thermogravimetric Analysis (TGA), which removes the organic material and water, thereby leaving the inorganic material, and one of skill in the art can back-calculate to determine the amount of total resin solids.

The terms “polymer” and “polymeric material” include, but are not limited to, organic homopolymers, copolymers, such as for example, block, graft, statistical, including random, and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element, or group of steps or elements, but not the exclusion of any other step or element, or group of steps or elements. The phrase “consisting of” means including, and limited to, whatever follows the phrase “consisting of.” Thus, the phrase “consisting of” indicates that the listed elements are required or mandatory, and that no other elements may be present. The phrase “consisting essentially of” means including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may, or may not, be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50). Herein, “at least” a number (e.g., at least 50) includes the number (e.g., 50). Herein, “no more than” a number (e.g., no more than 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” or “ambient temperature” refers to a temperature of 20 °C to 25 °C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the disclosure, guidance is provided through lists of examples, which examples may be used in various combinations. In each instance, the recited list serves only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### DETAILED DESCRIPTION OF ILLUSTRATIVE EMBODIMENTS

The present disclosure provides food or beverage container coating compositions, articles having a coating formed from such compositions (e.g., coated metal substrates and metal packaging formed from such substrates), and methods (e.g., methods of making a coating composition and methods of coating such composition).

Aqueous food or beverage container coating compositions described herein include: an acid- or anhydride-functional acrylic polymer; a phenolic crosslinker; and an aqueous liquid carrier. In one or more preferred embodiments, aqueous food or beverage containing coating compositions described herein include: at least 50 wt-%, based on total resin solids, of an at least partially neutralized acid- or anhydride-functional acrylic polymer; a phenolic crosslinker; and an aqueous liquid carrier. The present disclosure also provides an at least partially neutralized acid- or anhydride-functional acrylic polymer, which is preferably crosslinkable with a phenolic crosslinker upon coating cure conditions.

### Acrylic Polymers

The present disclosure provides an acid- or anhydride-functional acrylic polymer, preferably an at least partially neutralized acid- or anhydride functional acrylic polymer, and aqueous coating compositions that include such polymer, which is preferably crosslinked with a phenolic crosslinker.

An acrylic polymer is a polymer that is formed from, that is, polymerized from, a variety of acid- or anhydride-functional monomers, or salts thereof; their selection is dependent on the desired final polymer properties. Preferably, such monomers are ethylenically unsaturated, more preferably, alpha, beta-ethylenically unsaturated. Suitable ethylenically unsaturated acid- or anhydride-functional monomers for use in forming the acrylic polymer described herein include monomers having a reactive carbon-carbon double bond and an acidic or anhydride group, or salts thereof. Preferred such monomers have from 3 to 20 carbons, at least 1 site of unsaturation, and at least 1 acid or anhydride group, or salt thereof.

Suitable acid-functional monomers include ethylenically unsaturated acids (mono-protic or diprotic), anhydrides or monoesters of a dibasic acid, which are copolymerizable with the optional other monomer(s) used to prepare the polymer.

Illustrative monobasic acids are those represented by the structure CH₂═C(R¹)—COOH, where R¹ is hydrogen or an alkyl radical of 1 to 6 carbon atoms, and typically hydrogen or a methyl group. Suitable dibasic acids are those represented by the formulas R²(COOH)C═C(COOH)R³ and R²(R⁴)C═C(COOH)R³COOH, where R² and R³ are hydrogen, an alkyl radical of 1-8 carbon atoms, halogen, cycloalkyl of 3 to 7 carbon atoms or phenyl, and Reis an alkylene radical of 1 to 6 carbon atoms. Half-esters of these acids with alkanols of 1 to 8 carbon atoms are also suitable.

Non-limiting examples of useful ethylenically unsaturated acid-functional monomers include acids such as, for example, acrylic acid, methacrylic acid, alpha-chloroacrylic acid, alpha-cyanoacrylic acid, crotonic acid, alpha-phenylacrylic acid, beta-acryloxypropionic acid, fumaric acid, maleic acid, sorbic acid, alpha-chlorosorbic acid, angelic acid, cinnamic acid, p-chlorocinnamic acid, beta-stearylacrylic acid, citraconic acid, mesaconic acid, glutaconic acid, aconitic acid, tricarboxyethylene, 2-methyl maleic acid, itaconic acid, 2-methyl itaconic acid, methyleneglutaric acid, and the like, or mixtures thereof. Preferred unsaturated acid-functional monomers include acrylic acid, methacrylic acid, crotonic acid, fumaric acid, maleic acid, 2-methyl maleic acid, itaconic acid, 2-methyl itaconic acid, and mixtures thereof. More preferred unsaturated acid-functional monomers include acrylic acid, methacrylic acid, crotonic acid, fumaric acid, maleic acid, itaconic acid, and mixtures thereof. Most preferred unsaturated acid-functional monomers include acrylic acid, methacrylic acid, and mixtures thereof.

Other certain acid-functional monomers include phosphorus-containing (e.g., phosphoric acid-functional or phosphonic acid-functional) monomers and sulfur-containing (e.g., sulfonic acid-functional) monomers.

Nonlimiting examples of suitable ethylenically unsaturated anhydride monomers include compounds derived from the above acids (e.g., as pure anhydride or mixtures of such). Preferred anhydrides include acrylic anhydride, methacrylic anhydride, and maleic anhydride. If desired, aqueous salts of the above acids may also be employed.

The acrylic polymer includes acid- or anhydride-functional groups, at least some of which are neutralized to form salt groups. For example, meth (acrylic) monomers include an acid group. In some embodiments, the polymers of the present disclosure may include monomers that include acid groups that are not (meth)acrylic monomers, including, for example, sorbic acid. While not intending to be bound by theory, the acrylic polymers with such groups are used to encapsulate and stabilize the phenolic crosslinker.

Acrylic polymers are typically, and preferably, synthesized using radical polymerization (also referred to as free-radical polymerization). Generally, there are two methods to synthesize an acrylic polymer using radical polymerization. In one method, radical polymerization is conducted in a solvent medium. The viscosity of and/or the homogeneity of the solution including the solvent medium often results in low (e.g., polymers with a weight average molecular weight (Mw) or number average molecular weight (Mn) that is typically less than 50,000 Da, more often less than 15,000 Da, and in some embodiments, less than 10,000 Da) or medium (e.g., polymers with an Mw or Mn of 50,000 Da to less than 100,000 Da) molecular weight polymers. In a different method, acrylic polymers may be synthesized via radical emulsion polymerization. Radical emulsion polymerization often leads to high molecular weight polymers (e.g., polymers with an Mw or Mn of 100,000 Da or more, and even in the millions), such as for a latex polymer.

In some embodiments, the acid- or anhydride-functional acrylic polymer or the at least partially neutralized acid- or anhydride functional acrylic polymer is an organic-solution polymerized acrylic polymer. “Organic-solution polymerized” means that the acrylic polymer is formed by radical polymerizing an ethylenically unsaturated monomer component in an organic solvent, which typically forms a continuous phase of the reaction mixture. Suitable organic solvents include ketones, glycol ethers, esters, alcohols, aromatics, or combinations thereof. Examples of such solvents include cyclohexanone, ethylcarbitol, butyl carbitol, butylcellosolve, butanol, amyl alcohol, methyl isobutyl ketone, methyl isoamyl ketone, methyl amyl ketone, xylene, AROMATIC 150 (Chemical Abstract Services (CAS) number: 64742-94-5), AROMATIC 100 (CAS number: 64742-95-6), hexylcellosolve, toluene, propylene glycol monomethyl ether acetate, propylene glycol monomethyl ether, dibasic ester, diisobutyl ketone, and mixtures thereof.

A catalyst or polymerization initiator is ordinarily used in the polymerization of acrylic polymers, in the usual amounts. This can be any suitable free radical initiator. For example, azoalkanes, peroxides, tertiary butyl perbenzoate, tertiary butyl peroxypivalate, and tertiary butyl peroxyisobutyrate are suitable.

In certain embodiments, the acrylic polymer is a copolymer of two or more prepolymers (preferably two or more acrylic prepolymers). In this context, a “prepolymer” is a polymeric starting material used to make the final acrylic polymer. Such prepolymers are formed from an ethylenically unsaturated monomer component.

In certain embodiments, the ethylenically unsaturated monomer component of the acrylic polymer and/or prepolymers include acid-functional monomers, optionally hydroxyl-functional monomers, and optionally other monomers referred to herein as secondary monomers (the term “secondary does not necessarily correlate to the amount of such monomers). As used herein, a “secondary monomer” is a monomer that does not include an acid, anhydride, or hydroxyl functionality or other active hydrogen group, and includes monomers such as, for example, alkyl (meth)acrylates, cycloalkyl (meth)acrylates, aryl (meth)acrylates, styrene, and the like. Exemplary secondary monomers include alkyl, cycloalkyl, or aromatic (meth)acrylate monomers.

In certain embodiments, at least one, or each (i.e., all), of the two or more prepolymers is an at least partially neutralized acid- or anhydride-functional acrylic prepolymer. In certain embodiments, at least one, or each (i.e., all), of the two or more prepolymers is an organic-solution polymerized acrylic prepolymer. By this it is meant that the prepolymer is polymerized in an organic solvent as described herein.

In certain embodiments, the acrylic polymer is hydroxyl-functional (i.e., includes one or more hydroxyl groups), wherein such group may be used for crosslinking with the phenolic crosslinker. In certain embodiments, at least one of the acrylic prepolymers, and preferably each of the two or more acrylic prepolymers if used to form the acrylic polymer, is a hydroxyl-functional prepolymer. In certain embodiments, the acrylic polymer, and/or at least one, preferably each, acrylic prepolymer if used to form the acrylic polymer, has a calculated hydroxyl number of less than 120, less than 60, or less than 30 mg KOH per gram resin. In certain embodiments, the acrylic polymer, and/or at least one, preferably each, acrylic prepolymer if used to form the acrylic polymer, has a calculated hydroxyl number of at least 5, at least 15, or at least 28 mg, KOH per gram resin.

The acrylic polymer and/or prepolymers, if used to form the acrylic polymer, preferably have an acid number. Acid numbers may be calculated or determined experimentally (see Test Methods) from the acid-functional monomers of the ethylenically unsaturated monomer component. There are often differences between calculated and experimentally determined acid numbers. The differences arise because calculated acid numbers only consider the amount of the acid-functional monomer while the experimental method considers all acids in solution, which may include other sources of acids in addition to the acid-functional monomer. For the purposes of this discussion, acid-functional monomers are those that will react with an organic base or inorganic base, such as KOH, under ambient conditions, and typically include carboxylic acid-functional monomers, as well as others that will also react with KOH under ambient conditions, such as certain phosphorus-containing (e.g., phosphoric acid-functional or phosphonic acid-functional) monomers and certain sulfur-containing (e.g., sulfonic acid-functional) monomers may be included in the calculation of acid number. Exemplary structures of acid-functional monomers are as follows:

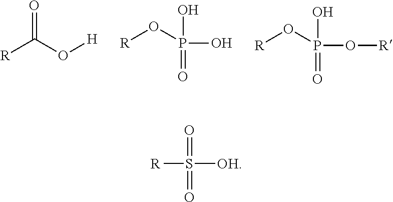

If the ethylenically unsaturated monomer component includes acid-functional monomer(s) other than carboxylic acid-functional monomers (e.g., phosphorus- or sulfur-containing acid-functional monomers), such non-carboxylic acid-functional monomers are preferably present in an amount of less than 50 wt-%, less than 25 wt-%, less than 10 wt-%, less than 5 wt-%, less than 2 wt-%, or less than 1 wt-%, if any, based on the total weight of the acid-functional monomers in the ethylenically unsaturated monomer component. Preferably, however, only carboxylic acid-functional monomers are included in the calculation of acid number. Unless otherwise stated, the acid numbers herein are calculated acid numbers.

In certain embodiments, the acrylic polymer has a calculated acid number of less than 60 mg KOH per gram resin. In certain embodiments, all the acrylic prepolymers, if used to form the acrylic polymer, have an acid number within +10 mg KOH per gram resin. In certain embodiments, at least one, preferably each, of the two or more acrylic prepolymers, if used to form the acrylic polymer, has a calculated acid number. Suitable acrylic polymers, and/or at least one, preferably each, acrylic prepolymer if used to form the acrylic polymer, for use in an aqueous food or beverage container coating composition have a calculated acid number of less than 50 mg, less than 40 mg, or less than 35 mg, KOH per gram resin. In certain embodiments, the acrylic polymer, and/or at least one, preferably each, acrylic prepolymer if used to form the acrylic polymer, has a calculated acid number of at least 8 mg, at least 10 mg, at least 20 mg, at least 30 mg, or at least 32 mg, KOH per gram resin. In some embodiments, the calculated acid values of this paragraph are achieved via the amount of carboxylic-acid monomer used (an anhydride-functional monomer is considered as a carboxylic-acid monomer as an anhydride group yields two carboxylic groups), while not factoring as acid monomer any non-carboxylic acid monomers that may be present, if any. That is, the calculated acid number only factors acid monomers including a carboxylic acid group, an anhydride group (which yields two carboxylic groups), or a salt group thereof.

Preferably, the acrylic polymers of the present disclosure are at least partially neutralized, and therefore have a “degree of neutralization.” This at least partial neutralization of the acrylic polymer contributes to the stability and/or viscosity of the aqueous dispersion of the acrylic polymer. For example, as the degree of neutralization increases, the solubility of the polymer may increase at a constant acid number. Increase in the solubility of the polymer at a constant acid number may result in an increased viscosity.

The degree of neutralization is calculated as the amount of base (e.g., N,N-dimethylethanolamine) added to the solution containing the polymer and/or prepolymer divided by the calculated acid number of said polymer and/or prepolymer. For the same reason why there are often differences in calculated and experimental acid numbers, the degree of neutralization can be greater than 100%. For example, a polymer that has a calculated acid number of 8 mg KOH per gram resin may have an experimentally determined acid number of 18 mg KOH per gram resin, meaning there are other sources of acid in addition to the acid-functionalized polymer in the solution that are also being neutralized. The addition of more than 8 mg of a base would result in a degree of neutralization greater than 100%, even though not all of the acid-functional monomer groups may or may not be neutralized.

In certain embodiments, the acrylic polymers of the present disclosure are at least partially neutralized with a base, preferably a fugitive base (also known as a volatile base or volatile fugitive base). Nonlimiting examples of volatile fugitive bases include various amines such as ammonium, ethylamine, dimethylethanolamine, triethanolamine, triethylamine, dimethylamine, and combinations thereof.

In certain embodiments, the acrylic polymer has a degree of neutralization of no more than 200%, no more than 150%, no more than 100%, no more than 80%, or no more than 60%, based on an acid number of at least 8 mg KOH per gram resin. In certain embodiments, the acrylic polymer has a degree of neutralization of no more than 150%, no more than 100%, no more than 80%, or no more than 60%, based on an acid number of at least 15 mg KOH per gram resin. In certain embodiments, the acrylic polymer has a degree of neutralization of no more than 100%, no more than 80%, or no more than 60%, based on an acid number of at least 20 mg KOH per gram resin. In certain embodiments, the acrylic polymer has a degree of neutralization of no more than 80%, or no more than 60%, based on an acid number of at least 32 mg KOH per gram resin. In certain embodiments, the acrylic polymer has a degree of neutralization of no more than 100%, no more than 80%, or no more than 60%, based on an acid number of at least 40 mg KOH per gram resin. In certain embodiments, the acrylic polymer has a degree of neutralization of at least 20%, at least 30%, or at least 40%, based on an acid number of at least 50 mg KOH per gram resin.

In certain embodiments, the acrylic polymer is self-dispersible in water. In certain embodiments, at least one, preferably each, of the two or more acrylic prepolymers, if used to prepare the acrylic polymer, is self-dispersible in water. By “self-dispersible” in water, it is meant, no additive (other than a neutralizing base), such as a surfactant, is needed to disperse the acrylic polymer.

At least because the phenolic crosslinker is pH sensitive, the acid number, hydroxyl number, and degree of neutralization are preferably balanced to provide a stable dispersion of the mixture of phenolic crosslinker and acrylic polymer in water. It is contemplated that through careful monomer selection, in some embodiments, no neutralization is necessary to form a stable dispersion of the mixture of the phenolic crosslinker and acrylic polymer in water.

In certain embodiments, the acrylic polymer is prepared from two or more at least partially neutralized acid- or anhydride-functional organic-solution polymerized acrylic prepolymers, wherein: at least one acrylic prepolymer is hydroxyl-functional; each of the two or more acrylic prepolymers preferably has a calculated acid number of less than 60 mg KOH per gram resin; and each of the two or more acrylic prepolymers is self-dispersible in water.

In certain embodiments, the acrylic polymer is a single-stage polymer, that is, the acrylic polymer has a single glass transition temperature (Tg). The glass transition temperature (Tg) can be measured, for example, using differential scanning calorimetry (DSC) or calculated using the Fox Equation. In certain embodiments, a cured coating of the coating composition containing the acrylic polymer has a single Tg, measured, for example, using DSC. Preferably, the single Tg of the cured coating is greater than 50 °C (which is the temperature of the hot room for food cans).

In certain embodiments, the acrylic polymer has a calculated (aggregate of all monomers) Tg of at least 35 °C, at least 40 °C, at least 45 °C, or at least 50 °C (and in certain embodiments up to 95 °C). In certain embodiments, at least one, preferably each, of the two or more acrylic prepolymers, if used to prepare the acrylic polymer, has a calculated (aggregate of all monomers) Tg of at least 35 °C, at least 40 °C, at least 45 °C, or at least 50 °C (and in certain embodiments up to 95 °C).

Herein, a “calculated Tg” is used interchangeably with “Fox Tg” and “calculated Fox Tg.” The Tg of a particular polymer or prepolymer can be estimated (i.e., calculated) using the Fox equation. For example, for a polymer or prepolymer made from two monomers, the theoretical Tg may be calculated using the Fox equation as follows:

$$\frac{1}{Tg} = \frac{{W}_{a}}{{Tg}_{a}} + \frac{{W}_{b}}{{Tg}_{b}}$$

wherein:
Tgₐ and Tg_{b} are the respective glass transition temperatures in Kelvin of homopolymers made from monomers “a” and “b”; and Wₐ and W_{b} are the respective weight fractions of polymers “a” and “b”. When additional monomer feeds “c” and “d” and so on are employed, additional fractions W_{c}/Tg_{c}, W_{d}/Tgₐ and so on are added to the right-hand side of the above equation. Unless indicated otherwise, the “calculated” Tg's referenced herein are calculated using the Fox equation. Also, the calculation is based on all of the monomers that are reacted together to form a polymer or prepolymer, and not upon merely a portion of such monomers.

The Fox equation cannot be used to calculate the Tg of a polymer crosslinked with a crosslinking agent or a composition containing a polymer and a crosslinking agent.

The value of Tg of the monomers used to estimate the polymer or prepolymer Tg are based on literature values. Typically, there is some variation of the Tg values of the homopolymers of monomers listed in such literature. The difference arises from the test method used to measure the Tg. The differences can also arise from influence of comonomers polymerized together. For the purposes of this disclosure, the values used for the homopolymer Tg of certain monomers, particularly monomers used in the examples are listed herein (e.g., in the Materials Table in the Examples Section). Alternatively, the method of determining the Tg of a homopolymer can be determined using the differential scanning calorimetry (DSC) procedure described in the Test Methods, particularly if the literature values are significantly different from one another (e.g., the literature values vary by at least 15 °C). If the literature values vary by less than 15 °C, then the lower literature value is used.

In certain embodiments, the acrylic polymer has a number average molecular weight (Mn) of at least 6,000 Da, at least 8,000 Da, at least 10,000 Da, or at least 12,000 Da, as determined using gel permeation chromatography (GPC) and a series of polystyrene standards with different molecular weights. In certain embodiments, the acrylic polymer has a Mn of up to 35,000 Da, up to 30,000 Da, up to 28,000 Da, or up to 25,000 Da, as determined using GPC and a series of polystyrene standards with different molecular weights.

In certain embodiments, at least one, preferably each, of the two or more acrylic prepolymers, if used to prepare the acrylic polymer, has a Mn of at least 6,000 Da, at least 8,000 Da, at least 10,000 Da, or at least 12,000 Da, as determined using GPC and a series of polystyrene standards with different molecular weights. In certain embodiments, at least one, preferably each, of the two or more acrylic prepolymers, if used to prepare the acrylic polymer, has a Mn of up to 35,000 Da, up to 30,000 Da, up to 28,000 Da, or up to 25,000 Da, as determined using GPC and a series of polystyrene standards with different molecular weights.

In certain embodiments, the one or more acid-functional monomers used to form the acrylic polymer and/or acrylic prepolymers of the present disclosure include acrylic acid, methacrylic acid, crotonic acid, unsaturated dicarboxylic acid or anhydride (e.g., maleic acid, fumaric acid, itaconic acid, and maleic anhydride), phosphorus-containing monomers, sulfur-containing monomers, monoalkyl maleate or anhydride, or combinations thereof. In certain embodiments, the one or more acid-functional monomers include (meth)acrylic acid (i.e., acrylic acid and methacrylic acid).

If used, phosphorus-containing acid-functional monomers include, for example, bis(2-methacryloxyethyl) phosphate, ethylene glycol methacrylate phosphate, phosphoric acid (meth)acrylate, phosphonic acid (meth)acrylate. If used, sulfur-containing acid-functional monomers include, for example, 2-propene-1-sulfonic acid, 2-acrylamido-2-methylpropane sulfonic acid, 2-sulfonyl-methacrylate, 2-methyl-2-propene-1-sulfonic acid sodium salt, 2-sulfonyl methacrylate potassium salt. Salts can be transferred to corresponding acids, or they can be polymerized directly with other monomers, like carboxylic acid monomers.

In certain embodiments, the acrylic polymers and/or prepolymers of the present disclosure include at least 1.0 wt-%, at least 1.5 wt-%, at least 2.0 wt-%, at least 2.5 wt-%, at least 3.0 wt-%, at least 3.5 wt-%, or at least 4.0 wt-%, interpolymerized acid-functional monomers, based on the total weight of the monomers. In certain embodiments, the acrylic polymers and/or acrylic prepolymers of the present disclosure include no more than 8 wt-%, no more than 7 wt-%, no more than 6 wt-%, or no more than 5 wt-%, interpolymerized acid-functional monomers, based on the total weight of the monomers. In preferred embodiments, the acrylic polymers and/or prepolymers of the present disclosure include an amount of acrylic acid and/or methacrylic acid pursuant to the above amounts.

In certain embodiments, one or more hydroxyl-functional monomers, particularly hydroxyl-functional (meth)acrylate monomers, may be used to form the acrylic polymer and/or acrylic prepolymers of the present disclosure. Exemplary such monomers include hydroxyethyl (meth)acrylate, hydroxypropyl (meth)acrylate, hydroxybutyl (meth)acrylate, mono- or di-ester of unsaturated dicarboxylic acid (e.g., maleic acid, fumaric acid, or itaconic acid), in which at least one of the esterified groups contains a hydroxyl group (e.g., mono (2-hydroxyethyl) maleate, 2-hydroxyethylbutyl maleate), or combinations thereof. Hydroxyl-functional (meth)acrylate monomers are preferred hydroxyl-functional monomers. In certain embodiments, the one or more hydroxyl-functional monomers include 2-hydroxyethyl (meth)acrylate (i.e., hydroxyethyl (meth)acrylate), 2-hydroxylpropyl (meth)acrylate (i.e., hydroxypropyl (meth)acrylate), hydroxybutyl (meth)acrylate, or combinations thereof.

In certain embodiments, the acrylic polymers and/or acrylic prepolymers of the present disclosure include at least 1.0 wt-%, at least 1.5 wt-%, at least 2.0 wt-%, at least 2.5 wt-%, at least 3.0 wt-%, at least 3.5 wt-%, at least 4.0 wt-%, at least 4.5 wt-%, at least 5.0 wt-%, or at least 5.5 wt-%, interpolymerized hydroxyl-functional monomers, based on the total weight of the monomers used in the polymerization reaction. In certain embodiments, the acrylic polymers and/or acrylic prepolymers of the present disclosure include no more than 35 wt-%, no more than 30 wt-%, no more than 25 wt-%, no more than 20 wt-%, no more than 15 wt-%, no more than 10 wt-%, or no more than 8 wt-%, interpolymerized hydroxyl-functional monomers, based on the total weight of the monomers used in the polymerization reaction.

In certain embodiments, the secondary monomers include (meth)acrylate monomers, in particular (C1-C8) (meth)acrylate monomers (e.g., methyl (meth)acrylate, ethyl (meth)acrylate, butyl (meth)acrylate, 2-ethylhexyl (meth)acrylate); difunctional (meth)acrylate monomers (e.g., 1,4-butanediol di(meth)acrylate, 1,6-hexanediol di(meth)acrylate, allyl (meth)acrylate); vinyl aromatic monomers (e.g., styrene and divinyl benzene); cyclohexyl (meth)acrylate; benzyl (meth)acrylate; or combinations thereof. In certain embodiments, the secondary monomers include methyl (meth)acrylate, ethyl (meth)acrylate, butyl (meth)acrylate, 2-ethylhexyl (meth)acrylate, styrene, cyclohexyl (meth)acrylate, benzyl (meth)acrylate, or combinations thereof. In certain embodiments, the secondary monomers include styrene.

In certain embodiments, the acrylic polymers and/or acrylic prepolymers of the present disclosure include at least 50 wt-%, at least 55 wt-%, at least 60 wt-%, at least 65 wt-%, at least 70 wt-%, at least 75 wt-%, at least 80 wt-%, or at least 85 wt-%, interpolymerized secondary monomers, based on the total weight of the monomers used in the polymerization reaction. In certain embodiments, the acrylic polymers and/or acrylic prepolymers of the present disclosure include no more than 98 wt-%, no more than 96 wt-%, or no more than 90 wt-%, interpolymerized secondary monomers, based on the total weight of the monomers used in the polymerization reaction.

In certain embodiments, the acrylic polymers and/or acrylic prepolymers of the present disclosure include no more than 40 wt-%, no more than 30 wt-%, no more than 20 wt-%, or no more than 10 wt-%, interpolymerized styrene monomers, based on the total weight of the monomers used in the polymerization reaction. In certain embodiments, the acrylic polymers and/or acrylic prepolymers of the present disclosure are styrene-free.

In preferred embodiments, the acrylic polymers and/or acrylic prepolymers of the present disclosure include no more than 10 wt-%, no more than 5 wt-%, no more than 1 wt-%, or no more than 0.1 wt-%, if any, of interpolymerized (meth)acrylamide monomers and derivatives thereof (e.g., methylol acrylamide). Furthermore, preferably, the acrylic polymers and/or acrylic prepolymers of the present disclosure are substantially free of interpolymerized (meth)acrylamide monomers and derivatives thereof; the acrylic polymers and/or acrylic prepolymers the present disclosure are essentially free of interpolymerized (meth)acrylamide monomers; the acrylic polymers and/or acrylic prepolymers of the present disclosure are essentially completely of free interpolymerized (meth)acrylamide monomers; or the acrylic polymers and/or acrylic prepolymers of the present disclosure are completely free of interpolymerized (meth)acrylamide monomers and derivatives thereof.

In certain embodiments, the acrylic polymers and/or acrylic prepolymers of the present disclosure are free of glycidyl (meth)acrylate (i.e., the reactants used to prepare the polymer and/or acrylic prepolymers did not include glycidyl (meth)acrylate). In certain embodiments, acrylic polymers and/or acrylic prepolymers of the present disclosure are free of oxirane-functional ethylenically unsaturated monomers altogether.

In certain embodiments, the acrylic polymers and/or acrylic prepolymers of the present disclosure do not include interpolymerized halogen containing monomers, such as, for example, vinyl chloride monomers. In certain embodiments, the acrylic polymers and/or acrylic prepolymers of the present disclosure are substantially free of interpolymerized halogen-containing monomers; the acrylic polymers and/or acrylic prepolymers the present disclosure are essentially free of interpolymerized halogen-containing monomers; the acrylic polymers and/or acrylic prepolymers of the present disclosure are essentially completely of free interpolymerized halogen-containing monomers; or the acrylic polymers and/or acrylic prepolymers of the present disclosure are completely free of interpolymerized halogen-containing monomers.

In certain embodiments, the acrylic polymers and/or acrylic prepolymers of the present disclosure do not include polyester-acrylic copolymers, polyether-acrylic copolymers (i.e., epoxy-acrylic copolymers), and/or polyurethane-acrylic copolymers. In certain embodiments, the acrylic polymers and/or acrylic prepolymers of the present disclosure are substantially free of polyester-acrylic copolymers, polyether-acrylic copolymers, and/or polyurethane-acrylic copolymers.

In some embodiments, the acrylic polymers and/or acrylic prepolymers of the present disclosure include polyester-acrylic copolymers, polyether-acrylic copolymers (i.e., epoxy-acrylic copolymers), and/or polyurethane-acrylic copolymers.

In certain embodiments, the acrylic polymers and/or acrylic prepolymers of the present disclosure comprise, and preferably include, interpolymerized (meth)acrylic acid monomers, (meth)acrylate monomers, or combinations thereof.

In certain embodiments, the acrylic polymers and/or acrylic prepolymers of the present disclosure include interpolymerized monomers including (meth)acrylic acid monomers, optionally hydroxyl-functional monomers, particularly hydroxyl-functional (meth)acrylate monomers such as hydroxypropyl (meth)acrylate monomers. Herein, (meth)acrylic acid monomers include acrylic acid monomers and methacrylic acid monomers. Also, (meth)acrylate monomers include acrylate monomers and methacrylate monomers.

In certain embodiments, the acrylic polymers and/or acrylic prepolymers of the present disclosure include interpolymerized secondary monomers including, for example, (C1-C12) (meth)acrylate monomers where the (C1-C12) group is covalently attached to the ester oxygen. Preferred such C1-C12 secondary groups include alkyl groups and cycloalkyl groups. In certain embodiments, the acrylic polymers and/or acrylic prepolymers of the present disclosure include interpolymerized secondary monomers include a (C1-C8) (meth)acrylate monomer, and in certain embodiments, a (C1-C4) (meth)acrylate monomer, and preferably, a C4 (meth)acrylate monomer (e.g., butyl (meth)acrylate). In certain embodiments, the acrylic polymers and/or prepolymers of the present disclosure include interpolymerized secondary monomers including a (C1-C8) acrylate monomer, and in certain embodiments, a (C1-C4) acrylate monomer, and preferably, a C4 acrylate monomer.

In a preferred embodiment, an at least partially neutralized acid- or anhydride-functional organic-solution polymerized acrylic crosslinked polymer is provided that includes interpolymerized monomers including (meth)acrylic acid monomers (and optionally one or more hydroxyl-functional monomers, particularly hydroxyl-functional (meth)acrylate monomers such as hydroxypropyl (meth)acrylate monomers, and typically also one or more secondary monomers such as one or more alkyl, cycloalkyl, or aromatic (meth)acrylate monomers); wherein the acrylic polymer is hydroxyl-functional, has a calculated acid number of less than 60 mg KOH per gram resin, is self-dispersible in water, and is crosslinked with at least 5 wt-% resole phenolic crosslinker, based on total resin solids.

The “D-values”—D10, D50, and D90—are the particle sizes that divide a sample's volume into a specified percentage when the particles are arranged on an ascending particle size basis. For example, for particle size distributions the median is called the D50 (or ×50 when following certain ISO guidelines). The D50 is the particle size in micrometers that splits the distribution with half above and half below this diameter. The Dᵥ50 (or Dᵥ0.5) is the median for a volume distribution. The D10 describes the particle size where ten percent of the distribution has a smaller particle size and ninety percent has a larger particle size. The D90 describes the particle size where ninety percent of the distribution has a smaller particle size and ten percent has a larger particle size. Unless specified otherwise herein, particle size of a particular material refers to the D50. D10, D50, and D90 refer to Dᵥ10, Dᵥ50, and Dᵥ90, respectively. The D-values specified herein may be determined by laser diffraction particle size analysis.

In certain embodiments, the acrylic polymer is in the form of particles having a particle size distribution having one, two, or all of the following: a D10 of less than 0.15 micrometer (i.e., micron), a D50 of less than 0.25 micrometer, a D90 of less than 0.50 micrometer. In certain embodiments, the acrylic polymer is in the form of particles having a particle size distribution having one, two, or all of the following: a D10 of at least 0.07 micrometer, a D50 of at least 0.10 micrometer, a D90 of at least 0.12 micrometer.

In certain embodiments, aqueous coating compositions of the present disclosure include at least 50 wt-%, at least 55 wt-%, or at least 60 wt-%, of the acrylic polymer, based on total resin solids. In certain embodiments, aqueous coating compositions of the present disclosure include up to 99 wt-%, up to 95 wt-%, up to 90 wt-%, up to 85 wt-%, or up to 80 wt-%, of the acrylic polymer, based on total resin solids.

### Phenolic Crosslinkers

The coating compositions of the present disclosure includes one or more hydroxyl-reactive crosslinker, which is preferably a phenolic crosslinker. Phenolic crosslinkers (i.e., phenolic-based crosslinkers, phenol-formaldehyde resins, or phenolic resins) are used in a wide variety of end use applications including metal packaging coatings based on polyester resins, epoxy resins, and acrylate resins. The use of such phenolic resins for metal packaging applications helps provide the optimum balance of flexibility, durability, chemical resistance, and film toughness.

There are two main types of phenolic resins, based on production methods and ratios of a phenol compound and an aldehyde (which is preferably formaldehyde). Resoles, or base-catalyzed phenol-formaldehyde resins, are made with a formaldehyde to phenol molar ratio of typically at least one (usually around 1.5). Novolaks (or novolacs) are phenol-formaldehyde resins with a formaldehyde (or other aldehyde) to phenol compound molar ratio of typically less than one. Resoles are made by reacting a phenol compound and an aldehyde (preferably formaldehyde) directly to produce a thermosetting network polymer. Novolacs are made by restricting the formaldehyde (or other aldehyde) to produce a prepolymer known as novolac, which can be molded and then cured with the addition of more formaldehyde and heat. There are many variations in both production and starting materials that are used to produce a wide variety of phenolic resins.

Formaldehyde and acetaldehyde are preferred aldehydes for producing phenolic resins. The phenol compound may be phenol or one or more of a variety of phenol-based compounds such as, for example, cresol, p-phenylphenol, p-tert-butylphenol, p-tert-amylphenol, and cyclopentylphenol. The use of bisphenol A, bisphenol F, and bisphenol S as phenols is preferably avoided.

In preferred embodiments, the coating composition includes a resole phenolic resin. Preferably, the resole phenol-formaldehyde resin is a water soluble methylol-containing (—CH: OH) thermal cure crosslinker. The resole resins formed have reactive methylol and hydroxyl groups. When heated, these groups can form methylene or methyl ether crosslinks through the elimination of water, typically without the use or addition of a curing agent.

In some embodiments, the resole crosslinker is etherified with an alcohol, for example, butanol. In some embodiments, the methylol groups of the resole resin are etherified. In some embodiments, the resole crosslinker is etherified with butanol to give a butylated resole resin (e.g., an at least partially butylated or fully butylated resole phenolic resin). Etherification of the resole crosslinker may serve to protect the reactive methylol groups. Etherification of the resole crosslinker may serve to form a solvent-based resin that is chemically stable at ambient temperatures. During curing at elevated temperatures, the free methylol groups are regenerated from the etherified methylol group through the release of the alcohol used to etherify the methylol. For example, when the methylol groups are etherified with butanol, curing the resole resin results in the release of butanol and the regeneration of the free methylol groups.

In some embodiments, the coating composition includes one or more etherified resins, preferably, one or more butylated resole resins. In some embodiments, the coating composition does not include resole resins that are not etherified. In some embodiments, the etherified resole resin, preferably the one or more butylated resole resins, are cresol and/or phenol-based (i.e., made from cresol or phenol) resole resins.

In some embodiments, the coating composition may include a mixture of one or more resole resins that are not etherified and one or more etherified resole resins (preferably butylated resole resin). In such embodiments, the total amount of the one or more non-etherified resole resins is 20 wt-% or less, 10 wt-% or less, or 5 wt-% or less of the total amount of resole resin in the coating composition. Said another way, in such embodiments, the total amount of the one or more etherified (preferably butylated) resole resins is 80 wt-% or more, 90 wt-% or more, or 95 wt-% or more of the total amount of resole resin in the coating composition.

In certain embodiments, the resole phenolic resin has a number average molecular weight (Mn) determined by GPC of at least 600 Daltons (Da), or at least 900 Da. In certain embodiments, the resole phenolic resin has an Mn of up to 1200 Da, or up to 1100 Da.

In some embodiments, the resole phenolic crosslinker is a commercially available resole phenolic crosslinker. Examples of commercially available resole phenolic crosslinkers include, but are not limited to, those commercially available under the tradenames BAKELITE PF6535 LB, (butylated phenol-based resole resin available from Hexion in Columbus, OH), BAKELITE PF6581 LB (butylated phenol-based resole resin available from Hexion in Columbus, OH), BAKELITE PF6520 LB (butylated phenol-based resole resin available from Hexion in Columbus, OH), BAKELITE PF7835 LB (butylated phenol-based resole resin available from Hexion in Columbus, OH), DUREZ 34285 (butylated phenol-based resole resin available from SBHPP in Novi, MI), DUREZ 37145 (butylated phenol-based resole resin available from SBHPP in Novi, MI), DUREZ 34185 (t-butylated phenol-based resin available from SBHPP in Novi, MI), PHENOLDUR PR612 (butylated cresol-based resin available from Allnex in Kalamazoo, MI), and PHENOLDUR PR616 (butylated cresol-based resin available from Allnex in Kalamazoo, MI).

The amount of phenolic crosslinker used will depend, for example, on the type of phenolic crosslinker, the time and temperature of the bake, and the molecular weight of the acrylic polymer.

In certain embodiments, the amount of phenolic crosslinker (preferably, resole phenolic crosslinker) is preferably present in an aqueous coating composition in an amount of at least 1 wt-%, at least 2 wt-%, at least 5 wt-%, at least 10 wt-%, at least 15 wt-%, or at least 20 wt-%, based on total resin solids of the coating composition. Alternatively stated, an acrylic polymer of the present disclosure is crosslinked with at least 1 wt-%, at least 2 wt-%, at least 5 wt-%, at least 10 wt-%, at least 15 wt-%, or at least 20 wt-%, of a phenolic crosslinker (preferably, resole phenolic crosslinker), based on total resin solids of the coating composition.

In certain embodiments, the amount of phenolic crosslinker (preferably, resole phenolic crosslinker) is preferably present in an aqueous coating composition in an amount of up to 50 wt-%, up to 40 wt-%, up to 30 wt-%, up to 20 wt-%, or up to 10 wt-%, based on total resin solids of the coating composition. Alternatively stated, an acrylic polymer of the present disclosure is crosslinked with up to 50 wt-%, up to 40 wt-%, up to 30 wt-%, up to 20 wt-%, or up to 10 wt-%, of the phenolic crosslinker (preferably, resole phenolic crosslinker), based on total resin solids of the coating composition. Too much phenolic crosslinker can form an unstable coating composition. Pure cured phenolic is a very rigid material which may result in poor coating film and/or may affect the physical stability of the dispersion. In certain embodiments, the resole is an etherified resole. Etherified resoles may have improved chemical stability in bulk or formulation than non-etherified resole.

### Optional Ingredients

In certain embodiments, the coating compositions of the present disclosure may include one or more optional ingredients (i.e., optional additives). Such optional ingredients are preferably selected to not adversely affect the coating composition or a cured coating resulting therefrom. Such optional ingredients are typically included in a coating composition to enhance composition esthetics, to facilitate manufacturing, processing, handling, and application of the composition, and to further improve a particular functional property of a coating composition or a cured coating resulting therefrom.

Each optional ingredient is included in a sufficient amount to serve its intended purpose, but not in such an amount to adversely affect a coating composition or a cured coating resulting therefrom. The amounts of such optional ingredient can be determined readily by one of skill in the art.

Examples of suitable optional ingredients include catalysts, dyes, pigments (e.g., TiO₂, carbon black), anti-staining agents (e.g., ZnO), toners, extenders, fillers, lubricants, anticorrosion agents, flow-control agents, thixotropic agents, dispersing agents (e.g., wax dispersants), antioxidants, adhesion promoters, light stabilizers, curing agents, surfactants, or mixtures thereof.

A particularly useful optional ingredient is a pigment, like titanium dioxide (TiO₂). A pigment is optionally present in the coating composition in an amount of up to 50 wt-%, based on the total weight of the nonvolatile material. In certain embodiments, preferred coating compositions of the present disclosure include TiO₂ and optionally carbon black.

In certain embodiments, coating compositions of the present disclosure include a surfactant, which may be a polymeric or small molecule surfactant. In certain embodiments, if a composition includes any surfactant, it includes at least 0.01 wt-%, at least 0.1 wt-%, at least 0.5 wt-%, or at least 1 wt-%, surfactant (polymeric or small molecule surfactant), based on the total weight of total resin solids. In certain embodiments, if a composition includes any surfactant, it includes no more than 5 wt-%, no more than 2 wt-%, no more than 1 wt-%, or no more than 0.5 wt-%, surfactant (polymeric or small molecule surfactant), based on the total weight of total resin solids.

The amount of the surfactant may affect the properties of the coating. For example, too much can cause incompatibility and coating blush issues. Additionally, too much surfactant may reduce the coating's water and/or chemical resistance, result in foams, and/or affect the coating's Tg. In certain embodiments, preferred coating compositions of the present disclosure include no surfactant.

Suitable surfactants may be polymeric or small molecule surfactants (i.e., low molecular weight surfactants). The surfactant may be a defoamer, e.g., silicon-based surfactants such as those available under the trade designation AGITAN 731 from Münzing Chemie in Clover, SC. The surfactant may be a leveling agent, e.g., acrylic-based surfactants such as those available under the trade designation MODAFLOW from Allnex in Kalamazo, MI.

Generally, there are two approaches to prepare a water-based acrylic dispersion. In approach one, an external surfactant, either a low molecular weight surfactant or polymeric surfactant, is used to stabilize a hydrophobic acrylic to form a dispersion via a double layer morphology or a graft copolymer approach (e.g., an acrylic polymeric surfactant grafted to a hydrophobic acrylic polymer). A low molecular weight surfactant can result in poor water resistance and corrosion resistance in a cured coating film. A polymeric surfactant, on the other hand, usually contains 40-60% of unsaturated carboxylic acid monomer. When it is partially neutralized with an appropriate organic base, the acrylic surfactant stabilizes a hydrophobic polymer and forms an acrylic dispersion. This type of dispersion has an uneven distribution of hydrophilic acidic groups in the dispersion system. The resultant cured film, therefore, can be water sensitive due to the unreacted acidic group. This type of surfactant, therefore, has some drawbacks.

In approach two, a surfactant-free acrylic dispersion is prepared from a high acid or low acid content polymer resin, where the acid groups are randomly distributed on the backbone of the polymer, in the presence of an appropriate organic base. This approach improves water resistance and corrosion resistance; however, it is difficult to make a stable acrylic dispersion containing a phenolic resin. As such, surfactant-free acrylic dispersions made using approach two generally do not include a phenolic resin.

While not intending to be bound by theory, in preferred embodiments of the coating compositions of this disclosure, a surfactant-free acrylic resin not only stabilizes itself but also stabilizes a phenolic resin by encapsulating it and forming a uniform coating composition. The stability of this dispersion depends on the hydrophilic-lipophilic balance of the acid- or anhydride-functional acrylic polymer. For example, an acid- or anhydride-functional acrylic polymer that is too lipophilic will result in an aqueous coating composition that has two distinct phases, not a dispersion. An acid- or anhydride-functional acrylic polymer that is too hydrophilic will result in an aqueous coating composition that is a highly viscous dispersion or, in some cases, even homogeneous solution of one phase. Factors affecting the hydrophilicity and lipophilicity of polymers include the acid number, the hydroxyl number, the degree of neutralization, and the polarity of the monomers. Generally, the greater number of acid groups (higher acid number) and the greater the number of hydroxy groups (higher hydroxyl number), the greater degree of hydrophilicity. Nonpolar monomers or monomers that have low polarity generally increase the lipophilicity of the polymer. The approach of the present disclosure strikes a balance between hydrophilicity and lipophilicity of an acid- or anhydride-functional acrylic polymer to allow for surfactant-free aqueous coating compositions containing phenolic resin. This approach also provides a favorable total solids-viscosity relationship with low acid content and results in a high amount of total solids at a viscosity suitable for spraying to form coatings of adequate film thickness.

### Coating Compositions

In one embodiment, an aqueous food or beverage container coating composition (preferably, an aqueous food container coating composition) is provided that includes: at least 50 wt-%, based on total resin solids, of an at least partially neutralized acid- or anhydride-functional organic-solution polymerized acrylic polymer; a phenolic crosslinker; and an aqueous liquid carrier; wherein the coating composition is storage stable for at least 2 months, at ambient temperature, not in direct sunlight, without any phase separation as determined by the unaided human eye. In this embodiment, the acrylic polymer is hydroxyl-functional, has a calculated acid number of less than 60 mg KOH per gram resin, and is self-dispersible in water.

In a second embodiment, an aqueous food or beverage container coating composition (preferably, an aqueous food container coating composition) is provided that includes: at least 50 wt-%, based on total resin solids, of an at least partially neutralized acid- or anhydride-functional organic-solution polymerized acrylic polymer; at least 5 wt-% phenolic crosslinker, based on total resin solids; and an aqueous liquid carrier. In this embodiment, the acrylic polymer is hydroxyl-functional, has a calculated acid number of less than 60 mg KOH per gram resin, and is self-dispersible in water.

In a third embodiment, an aqueous food or beverage container coating composition (preferably, an aqueous food container coating composition) is provided that includes: at least 50 wt-%, based on total resin solids, of an acrylic polymer prepared from two or more at least partially neutralized acid- or anhydride-functional organic-solution polymerized acrylic prepolymers; a phenolic crosslinker; and an aqueous liquid carrier; wherein the coating composition is storage stable for at least 2 months, at ambient temperature without any phase separation as determined by the unaided human eye. In this embodiment, at least one acrylic prepolymer is hydroxyl-functional, each of the two or more acrylic prepolymers has a calculated acid number of less than 60 mg KOH per gram resin, and each of the two or more acrylic prepolymers is self-dispersible in water.

In a fourth embodiment, an aqueous food or beverage container coating composition (preferably, an aqueous food container coating composition) is provided that includes: at least 50 wt-%, based on total resin solids, of an acrylic polymer prepared from two or more at least partially neutralized acid- or anhydride-functional organic-solution polymerized acrylic prepolymers; at least 5 wt-% of a phenolic crosslinker, based on total resin solids; and an aqueous liquid carrier. In this embodiment, at least one acrylic prepolymer is hydroxyl-functional, each of the two or more acrylic prepolymers has a calculated acid number of less than 60 mg KOH per gram resin, and each of the two or more prepolymers is self-dispersible in water.

In a fifth embodiment, an aqueous food or beverage container coating composition (preferably, an aqueous food container coating composition) is provided that includes: at least 50 wt-%, based on total resin solids, of an at least partially neutralized acid- or anhydride-functional organic-solution polymerized acrylic polymer; at least 20 wt-% of a phenolic crosslinker, based on total resin solids; and an aqueous liquid carrier; wherein the coating composition includes 20 wt-% to 40 wt-% of total solids, based on the total weight of the composition, and is storage stable for at least 2 months at ambient temperature without any phase separation as determined by the unaided human eye. In this embodiment, the acrylic polymer is hydroxyl-functional, has a calculated acid number of less than 60 mg KOH per gram resin, and is self-dispersible in water.

The coating compositions of the present disclosure include an aqueous liquid carrier (e.g., water and/or an organic solvent).

In preferred embodiments, the coating compositions of the present disclosure include water and may further include one or more optional organic solvents. Such compositions are referred to herein as aqueous coating compositions.

In some embodiments, the coating composition includes at least 40 wt-%, or at least 50 wt-%, water, based on the total weight of the coating composition. In some embodiments, the coating composition includes no more than 60 wt-%, or no more than 55 wt-%, water, based on the total weight of the coating composition.

In some embodiments, the coating composition includes at least 0.1 wt-%, at least 0.5 wt-%, at least 1 wt-%, or at least 5 wt-%, of one or more organic solvents, based on the total weight of the coating composition. In some embodiments, the coating composition includes no more than 22 wt-%, or no more than 20 wt-%, of one or more organic solvents, based on the total weight of the coating composition.

In some embodiments, the aqueous liquid carrier includes at least 50 wt-%, at least 60 wt-%, at least 70 wt-%, or at least 80 wt-%, of water, based on the total weight of the liquid carrier. In some embodiments, the aqueous liquid carrier includes 100 wt-% or less, 95 wt-% or less, or 90 wt-% or less, of water, based on the total weight of the liquid carrier. In some embodiments, the liquid carrier is free or substantially free of organic solvent.

In some embodiments, the aqueous liquid carrier includes at least 50 wt-%, based on the total weight of the liquid carrier, of one or more organic solvents. In some embodiments, the organic solvent includes ethylene glycol monobutyl ether, ethylene glycol monohexyl ether, diethylene glycol monoethyl ether, isopropanol, butanol, or combinations thereof.

The amount of liquid carrier included in a coating composition of the present disclosure is limited by the desired, or necessary, rheological properties of the composition. Usually, a sufficient amount of carrier is included in the coating composition to provide a composition that can be processed easily and that can be applied to a metal substrate easily and uniformly using a particular application process, and that is sufficiently removed from the coating composition during curing within the desired cure time.

In some embodiments, a coating composition includes at least 62 wt-%, at least 64 wt-%, at least 66 wt-%, at least 68 wt-%, at least 70 wt-%, at least 72 wt-%, at least 74 wt-%, at least 76 wt-%, at least 78 wt-%, at least 80 wt-%, at least 82 wt-%, or at least 84 wt-% liquid carrier. In some embodiments, a coating composition will typically include up to 86 wt-%, up to 84 wt-%, up to 82 wt-%, up to 80 wt-%, up to 78 wt-%, up to 76 wt-%, up to 74 wt-%, up to 72 wt-%, up to 70 wt-%, up to 68 wt-%, up to 66 wt-%, up to 64 wt-%, up to 62 wt-%, or up to 60 wt-% liquid carrier. These weight percentages are based upon the total weight of the coating composition. The total solids may constitute the remainder of the weight of the aqueous composition.

Alternatively stated, in some embodiments, a coating composition includes up to 40 wt-%, up to 38 wt-%, up to 36 wt-%, up to 34 wt-%, up to 32 wt-%, up to 30 wt-%, up to 28 wt-%, up to 26 wt-%, up to 24 wt-%, up to 22 wt-%, up to 20 wt-%, up to 18 wt-%, or up to 16 wt-% total solids. In some embodiments, a coating composition will typically include at least 14 wt-%, at least 16 wt-%, at least 18 wt-%, at least 20 wt-%, at least 22 wt-%, at least 24 wt-%, at least 26 wt-%, at least 28 wt-%, at least 30 wt-%, at least 32 wt-%, at least 34 wt-%, at least 36 wt-%, or at least 38 wt-% total solids. In some embodiments, the coating composition includes 16 wt-% to 40 wt-% or 20 wt-% to 40 wt-% total solids. In some embodiments, the coating composition includes 24 wt-% to 34 wt-%, 14 wt-% to 22 wt-%, or 30 wt-% to 38 wt-% total solids. These weight percentages are based upon the total weight of the coating composition. The aqueous liquid carrier may constitute the remainder of the weight of the aqueous composition.

In certain embodiments, such as for certain spray coating applications (e.g., inside spray for food or beverage cans including, e.g., aluminum beverage cans), an aqueous coating composition includes solids in an amount of at least 5 wt-%, at least 10 wt-%, or at least 15 wt-%, based on total weight of the aqueous composition.

In certain embodiments, a coating composition has a viscosity of at least 50 centipoise (cps). In certain embodiments, a coating composition has a viscosity of up to 300 cps, or up to 200 cps. Viscosity of the coating composition can be measured using a viscometer (e.g., a Brookfield viscometer) at ambient temperature.

In certain embodiments, the coating compositions described herein have a pH of at least 7.5, or at least 8.0.

In certain embodiments, the coating compositions of the present disclosure are storage stable under normal storage conditions (e.g., ambient temperature and not stored in direct sunlight, such as when stored in a cabinet) for at least 2 months, preferably at least 3 months, more preferably at least 4 months, or most preferably at least 6 months. In this context, storage stable means that the compositions do not phase separate (e.g., separate into two or more layers) as determined by the unaided human eye.

In some embodiments, a cured coating formed from a coating composition of the present disclosure has a Tg of at least 50 °C. In some embodiments, the Tg of the cured coating is less than 110 °C, less than 80 °C, less than 70 °C, or less than 60 °C, for example, as measured using differential scanning calorimetry.

Coating compositions of the present disclosure are suitable for use on food or beverage containers. Preferably, they are suitable for use on the interior of a food or beverage container (e.g., on a food-contact or beverage-contact surface). More preferably, they are suitable for use on a food container, and most preferably, on the interior of a food container (e.g., a food-contact surface). For example, the coating compositions of the present disclosure may be inside spray two-piece drawn and ironed (D&I) food can coating compositions.

Accordingly, it is desirable to avoid the use of components that are unsuitable for the surfaces of food or beverage containers, particularly the interior surfaces (e.g., food-contact or beverage-contact surface), due to factors such as taste, toxicity, or other government regulatory requirements. For example, in preferred embodiments where the coating constitutes a food-contact or beverage-contact surface, the coating compositions are “PVC-free.” That is, the aqueous coating composition preferably contains, if any, less than 2 wt-% of vinyl chloride materials and other halogenated vinyl materials, more preferably less than 0.5 wt-% of vinyl chloride materials and other halogenated vinyl materials, and even more preferably less than 1 ppm of vinyl chloride materials and other halogenated vinyl materials, if any.

As a general guide to minimize potential concerns (e.g., taste and toxicity concerns) a cured coating formed from an aqueous coating composition of the present disclosure preferably includes, if it includes any detectable amount, less than 50 ppm, less than 25 ppm, less than 10 ppm, or less than 1 ppm, extractables, when tested pursuant to the Global Extraction Test in the Test Methods.

An example of these testing conditions is exposure of the cured coating to 10 wt-% ethanol solution for two hours at 121 °C, followed by exposure for 10 days in the ethanol solution at 40 °C. Such reduced global extraction values may be obtained by limiting the amount of mobile or potentially mobile species in the cured coating. In this context, “mobile” refers to material that may be extracted from a cured coating according to the Global Extraction Test of the Test Methods. This can be accomplished, for example, by using pure, rather than impure reactants, avoiding the use of hydrolyzable components or bonds, avoiding or limiting the use of low molecular weight additives that may not efficiently react into the coating, and using optimized cure conditions optionally in combination with one or more cure additives. This makes the cured coatings formed from the coating compositions described herein particularly desirable for use on food-contact surfaces.

Furthermore, preferably, the aqueous coating compositions, and preferably, the cured coatings, of the present disclosure are substantially free of each of bisphenol A, bisphenol F, and bisphenol S; the aqueous coating compositions, and preferably, the cured coatings, of the present disclosure are essentially free of each of bisphenol A, bisphenol F, and bisphenol S; the aqueous coating compositions, and preferably, the cured coatings, of the present disclosure are essentially completely free of each of bisphenol A, bisphenol F, and bisphenol S; or the aqueous coating compositions, and preferably, the cured coatings, of the present disclosure are completely free of each of bisphenol A, bisphenol F, and bisphenol S.

Preferably, tetramethyl bisphenol F (TMBPF; 4-[(4-hydroxy-3,5-dimethylphenyl)methyl]-2,6-dimethylphenol) is not excluded from the aqueous coating compositions or cured coatings of the present disclosure.

More preferably, the aqueous coating compositions, and preferably the cured coatings, of the present disclosure are substantially free of all bisphenol compounds not including TMBPF; the aqueous coating compositions, and preferably the cured coatings, of the present disclosure are essentially free of all bisphenol compounds not including TMBPF; the aqueous coating compositions, and preferably the cured coatings, of the present disclosure are essentially completely free of all bisphenol compounds not including TMBPF; or the aqueous coating compositions, and preferably the cured coatings, of the present disclosure are completely free of all bisphenol compounds not including TMBPF.

The term “bisphenol” refers to a polyhydric polyphenol having two phenylene groups that each include six-carbon rings and a hydroxyl group attached to a carbon atom of the ring, wherein the rings of the two phenylene groups do not share any atoms in common. By way of example, hydroquinone, resorcinol, catechol, and the like are not bisphenols because these phenol compounds only include one phenylene ring.

For example, an aqueous coating composition is not substantially free of bisphenol A that includes 600 ppm of bisphenol A and 600 ppm of the diglycidyl ether of bisphenol A (BADGE)—regardless of whether the bisphenol A and BADGE are present in the composition in reacted or unreacted forms, or a combination thereof.

The amount of bisphenol compounds (e.g., bisphenol A, bisphenol F, and bisphenol S) can be determined based on starting ingredients; a test method is not necessary and parts per million (ppm) can be used in place of weight percentages for convenience in view of the small amounts of these compounds.

Although with the notable exception of TMBPF, the intentional addition of some bisphenol compounds is now generally undesirable due to shifting consumer perceptions. It should be understood that non-intentional, trace amounts of bisphenol A, may potentially be present in compositions or coatings of the present disclosure due to, e.g., environmental contamination. Although bisphenols are an extremely broad and diverse class of chemical compounds with differing properties and the balance of scientific evidence available to date indicates that the small trace amounts of bisphenol compounds, such as bisphenol A, that might be released from existing coatings does not pose any health risks to humans, these compounds are nevertheless perceived by some people as being potentially harmful to human health. Consequently, there is a desire by some to eliminate these compounds from coatings on food- or beverage-contact surfaces, particularly food-contact surfaces.

In certain embodiments, a coating composition of the present disclosure, wherein when applied on a tin plate panel having a thickness of 0.0208 mm in an amount sufficient to achieve a dry film weight of 4-5 milligrams/square inch (mg/in²), after exposure to a temperature of 425 °F (218 °C) for 3.5 minutes, provides a cured coating having one or more of the following properties: an adhesion rating of at least 4B (i.e., 4B or 5B), when tested pursuant to the Adhesion Test in the Test Methods; a double rub rating of at least 30 or at least 50 when tested pursuant to the Solvent Resistance Test in the Test Methods (ASTM D 5402-93 for MEK rubs); or displaying no crazing when tested pursuant to the Reverse Impact Test (ASTM D2794-93) in the Test Methods.

### Coated Metal Substrates and Metal Packaging

The present disclosure provides coated metal substrates and metal packaging including the coated metal substrates. In certain embodiments, a metal substrate comprises a pre-treated or primed substrate.

The metal substrate is preferably of suitable thickness to form a metal food or beverage container (e.g., can). The metal substrate used in forming rigid containers (e.g., food or beverage cans), or portions thereof, typically has a thickness in the range of 125 micrometers to 635 micrometers (0.125 mm to 0.635 mm). In embodiments in which a metal foil substrate is employed in forming, e.g., a packaging article, the thickness of the metal foil substrate may be even thinner. Aluminum beverage cans and drawn and ironed (D&I) metal cans have different thicknesses in bottom and wall of the cans due to the drawing process.

Cured coatings of the disclosure preferably adhere well to metal (e.g., steel, stainless steel, electrogalvanized steel, tin-free steel (TFS), tin-plated steel, electrolytic tin plate (ETP), aluminum, etc.), which may or may not be pre-treated. They also provide high levels of resistance to corrosion or degradation that may be caused by prolonged exposure to, for example, food or beverage products.

Thus, metal substrates useful herein include steel, stainless steel, electrogalvanized steel, tin-free steel (TFS), tin-plated steel, electrolytic tin plate (ETP), aluminum, etc. Metal substrates useful herein also includes tab stock and aluminum coil for making beverage can ends (with the cured coating applied to an interior or exterior surface of the beverage can end, or both). Metal substrates herein may be provided in a coil or sheet form. Metal substrates herein may be provided as a preformed container (e.g., can or cup). Examples of metal cups that may benefit from coating compositions of the present disclosure are those described in U.S. Pat. No. 10,875,076 (Scott) and U.S. Pub. No. 2019/0112100 (Scott).

In the context of a cured adherent coating being disposed “on” a surface or substrate, both coatings applied directly (e.g., virgin metal or pre-treated metal such as electroplated steel) or indirectly (e.g., on a primer layer) to the surface or substrate are included. Thus, for example, a coating applied to a pre-treatment layer (e.g., formed from a chrome or chrome-free pretreatment) or a primer layer overlying a substrate constitutes a coating applied on (or disposed on) the substrate.

If a steel sheet is used as the metal substrate, the surface treatment may include one, two, or more kinds of surface treatments such as zinc plating, tin plating, nickel plating, electrolytic chromate treatment, chromate treatment, and phosphate treatment. If an aluminum sheet is used as the metal substrate, the surface treatment may include an inorganic chemical conversion treatment such as chromic phosphate treatment, zirconium phosphate treatment, or phosphate treatment; an organic/inorganic composite chemical conversion treatment based on a combination of an inorganic chemical conversion treatment with an organic component as exemplified by a water-soluble resin such as an acrylic resin or a phenol resin, and tannic acid; or an application-type treatment based on a combination of a water-soluble resin such as an acrylic resin with a zirconium salt.

In preferred embodiments, the cured adherent coating is continuous. As such, it is free of pinholes and other coating defects that result in exposed substrate, which can lead to (i) unacceptable corrosion of the substrate, and can even potentially lead to a hole in the substrate and product leakage, and/or (ii) adulteration of the packaged product. Except in embodiments in which coating roughness or texture is desired (e.g., for certain exterior can coatings for aesthetic purposes), the cured continuous coating is preferably smooth, especially for most interior can coatings.

In one embodiment, a coated metal substrate includes a metal substrate having a cured adherent coating disposed on at least a portion of a surface thereof, wherein the coating is formed from an aqueous coating composition as described herein.

In a preferred embodiment, a coated metal substrate includes a metal substrate having a cured adherent coating disposed on at least a portion of a surface thereof, wherein the coating is formed from an aqueous food container coating composition including: at least 50 wt-%, based on total resin solids, of an at least partially neutralized acid- or anhydride-functional organic-solution polymerized acrylic polymer; at least 20 wt-% of crosslinker including one or more phenolic crosslinkers (preferably, resole phenolic crosslinkers), based on total resin solids; and an aqueous liquid carrier. Preferably, the acrylic polymer is hydroxyl-functional, has a calculated acid number of less than 60 mg KOH per gram resin, and is self-dispersible in water.

In certain embodiments, the coated metal substrate has an average dry film coating weight of 0.5 mg/in² (0.08 mg/cm²) to 0.7 mg/in² (0.1 mg/cm²). Such coated metal substrates can be used to form a container such as a beverage can. Preferably, such container can be filled with a beverage product.

In certain embodiments, the coated metal substrate has an average dry film coating weight of 4 mg/in² (0.62 mg/cm²) to 5 mg/in² (0.78 mg/cm²). Such coated metal substrates can be used to form a container such as a food can. Preferably, such container can be filled with a food product.

Such coated metal substrates described herein can be used in making a variety of metal packaging products. The cured coatings may be used as coatings on any suitable surface, including inside surfaces of metal packaging container bodies (e.g., two-piece and three-piece food or beverage cans), outside surfaces of such container bodies, riveted can ends, pull tabs, and combinations thereof.

The cured coatings may also be used on interior or exterior surfaces of other packaging containers, or portions thereof, metal closures (e.g., for glass containers) including bottle crowns, recyclable aluminum beverage cups such as those commercially available from the Ball Corporation (Broomfield, CO). Such specific cans, cups, and other containers, with interior food- or beverage-contact surfaces, riveted can ends, and pull tabs have specific flexibility requirements, as well as taste, toxicity, and other government regulatory requirements.

### Methods

The present disclosure provides methods, particularly methods of making an aqueous food or beverage coating composition and methods of coating such composition to form a coated substrate, which is used in metal packaging.

In one embodiment, a method is provided that includes forming an aqueous food or beverage coating composition as described herein. The method initially includes polymerizing an ethylenically unsaturated monomer component in organic solvent (e.g., organic-solution polymerization) to form an acid- or anhydride-functional acrylic polymer having a calculated acid number of less than 60 mg KOH per gram polymer. The ethylenically unsaturated monomer component includes, for example, (meth)acrylic acid monomers, optionally hydroxyl-functional monomers, particularly hydroxyl-functional (meth)acrylate monomers such as hydroxypropyl (meth)acrylate monomers, and optionally secondary monomers (such as a (C1-C12) (meth)acrylate monomer and styrene as described herein). Such monomers and organic solvents are further described herein, as are other preferred characteristics (e.g., hydroxyl number, acid number, molecular weight) of the acrylic polymer, which is preferably halogen-free, bisphenol A, bisphenol F free, bisphenol S free, or combinations thereof. In some embodiments, the acid- or anhydride-functional acrylic polymer is styrene free.

The method also includes at least partially neutralizing the acid- or anhydride-functional acrylic polymer with a base, more preferably a fugitive base. Examples of fugitive bases used for neutralization include ammonia, ammonium hydroxide, an amine (e.g., a primary, secondary, or tertiary amine, with dimethylethanolamine being an example of a preferred amine), or a combination thereof. The degree of neutralization is further described herein.

Typically, the method includes adding a fugitive base to the polymer mixture to at least partially neutralize the acid- or anhydride-functional acrylic polymer to from an at least partially neutralized acid- or anhydride-functional acrylic polymer and a second mixture, and subsequently combining the second mixture with water to form an aqueous coating composition. Alternatively, the water and fugitive base can be combined with the acrylic polymer simultaneously.

The method also includes forming a mixture (e.g., by agitation) of the at least partially neutralized acid- or anhydride-functional acrylic polymer with a phenolic crosslinker. In certain embodiments, this step involves adding the phenolic crosslinker, which is provided in an organic solvent such as isopropanol, 1-methoxy-2-propanol, toluene, xylene, or combinations thereof (these solvents can be found in solvent-based phenolic compositions), to the at least partially neutralized acid- or anhydride-functional acrylic polymer, which is also in an organic solvent (typically the organic solvent in which the polymerization occurred).

Preferably, subsequently, the method includes combining the mixture of polymer and crosslinker with water to form an aqueous coating composition that includes (i) at least 50 wt-%, based on total resin solids, of the acrylic polymer and (ii) at least 5 wt-%, based on total resin solids, of the phenolic crosslinker. In certain embodiments, combining the mixture with water includes adding water to the mixture. This water addition can occur over a period of time, for example, over a period of one hour.

In certain embodiments, the aqueous coating composition includes at least 10 wt-%, at least 15 wt-%, or at least 20 wt-%, of the resole phenolic crosslinker, based on total resin solids. In certain embodiments, the aqueous coating composition includes up to 50 wt-%, up to 40 wt-%, up to 30 wt-%, up to 20 wt-%, or up to 10 wt-%, of the resole phenolic crosslinker, based on total resin solids.

The aqueous coating composition of the present disclosure are storage stable under normal storage conditions (e.g., ambient temperature) for at least 2 months, preferably at least 3 months, more preferably at least 4 months, or most preferably at least 6 months. In this context, storage stable means that the compositions do not phase separate (e.g., separate into two or more layers) as determined by the unaided human eye. Further aspects of the aqueous coating composition are further described herein.

Another method of the present disclosure includes a method of coating a food or beverage container. The method includes: providing an aqueous food or beverage container coating composition as described herein; causing the coating composition to be applied to at least a portion of a metal substrate (e.g., a steel or aluminum substrate) prior to or after forming the metal substrate into a food or beverage container or portion thereof; and thermally curing the coating composition to form a cured coating. In this context, “causing” means applying the coating composition to a metal substrate, instructing it to be applied to a metal substrate, or supplying it to a user to apply it to a metal substrate.

In certain embodiments, the substrate is a flat substrate, and the method further includes forming the flat metal substrate into at least a portion of a food or beverage container after thermally curing the coating composition.

In certain embodiments of such methods, the coating composition is applied to a preformed food or beverage container or a portion thereof. That is, in certain embodiments, the metal substrate is in the form of a preformed food or beverage container (e.g., a can having a sidewall and a bottom end), and spraying comprises spraying an interior surface of the container (e.g., sidewall and bottom end). Thus, in some embodiments, the coating composition is an inside spray beverage can coating composition, while, in other embodiments, the coating composition is an inside spray food can coating composition (e.g., for an aluminum D&I food can).

In certain embodiments of such methods, the coating composition is applied to a food- or beverage-contact surface of the metal substrate (e.g., an interior side of a food or beverage can or a surface that will become an interior side of a food or beverage can). Thus, methods of the present disclosure can involve applying the coating composition to a flat substrate, and then forming the flat metal substrate into at least a portion of a container (e.g., food or beverage can) after thermally curing the coating composition.

In certain embodiments of such methods, applying the coating composition includes spraying the coating composition onto the metal substrate (e.g., to the interior of partially or fully formed sidewall and end portions of a food or beverage can) in an amount sufficient to form a cured coating having a desired coating weight or coating thickness.

The disclosed coating compositions may be present as a layer of a mono-layer coating system or as one or more layers of a multi-layer coating system. The coating compositions can be used as a primer coat, an intermediate coat, a top coat, or a combination thereof. The coating thickness of a particular layer and of the overall coating system will vary depending upon the coating material used, the substrate, the coating application method, and the end use for the coated article. In certain embodiments, a coating prepared from a coating composition of the present disclosure, particularly if an inside container coating, has an average overall coating thickness of at least 1 micrometer, and often up to 20 micrometers.

Mono-layer or multi-layer coating systems including one or more layers formed from the disclosed coating compositions may have any suitable overall coating thickness, and typically are applied at an average dry film coating weight of 0.5 milligrams per square inch (mg/in²) (0.08 milligrams per square centimeter (mg/cm²)) to 0.7 mg/in² (0.1 mg/cm²) for beverage cans and 4 mg/in² (0.62 mg/cm²) to 5 mg/in² (0.78 mg/cm²) for food cans.

In certain embodiments, cured coatings of the coating compositions described herein have a high degree of flexibility, which can be a very useful property in food and beverage cans. Flexibility can be evaluated by the Reverse Impact Test described in the Test Methods (ASTM D2794-93), wherein a coating is applied to thin metal panel substrates, cured, and a standard weight is dropped from increasing distances onto the substrate until the failure point of the coating is reached. A coating is considered to satisfy the Reverse Impact Test if it does not display crazing (cracking) when a one pound (0.45 kg) standard weight is dropped from a height of 36 in (91.4 cm). The ability to pass the Reverse Impact Test is not necessarily dispositive as to whether a given coating exhibits sufficient flexibility for a given can coating end use. For example, in the case of inside spray beverage container coatings, the ability to pass a drop can test is generally considered dispositive. (See, e.g., the “Exposure After Drop Damage” test method disclosed in U.S. Publ. No. US20200199395). While a given coating would need to pass the Reverse Impact Test to have a chance at passing a drop can test, a given coating may pass the Reverse Impact Test, but still fail a drop can test.

The disclosed coating compositions may be applied to a substrate either prior to, or after, the substrate is formed into an article such as, for example, a food or beverage container or a portion thereof. In one embodiment, a method of forming food or beverage containers is provided that includes: applying (via roll coating, spray application, dipping, etc.) a coating composition described herein to a metal substrate (e.g., applying the composition to the metal substrate in the form of a planar coil or sheet), thermally curing the coating composition, and forming (e.g., via stamping) the substrate into a packaging container or a portion thereof (e.g., a food or beverage can or a portion thereof). For example, two-piece or three-piece cans or portions thereof, such as riveted beverage can ends (e.g., soda or beer cans), with a cured coating of the disclosed coating composition on a surface thereof, can be formed in such a method.

The disclosed coating compositions are particularly well adapted for use on food and beverage cans (e.g., two-piece cans, three-piece cans, etc.). Two-piece cans are manufactured by joining a can body (typically a drawn metal body) with a can end (typically a drawn metal end). The disclosed coatings are suitable for use in food or beverage contact situations and may be used on the inside of such cans (e.g., as an inside spray coating, for example, on a food- or beverage-contact surface of a metal substrate). They are particularly suitable for being spray applied, liquid coatings for the interior side of an article (e.g., two-piece drawn and ironed aluminum food and beverage cans and coil coatings for beverage can ends). The disclosed coating compositions also offer utility in other applications. These additional applications include, but are not limited to, wash coating, sheet coating, and side seam coatings (e.g., food can side seam coatings).

Spray coating methods include the introduction via spraying of a coating composition onto a surface, e.g., into the inside of a preformed packaging container. Typical preformed packaging containers suitable for spray coating include food cans, beer and beverage containers, and the like. The spray preferably utilizes a spray nozzle capable of uniformly coating the inside of the preformed packaging container. The sprayed preformed container is then subjected to heat to remove the carrier (i.e., water and/or organic solvents) and harden the coating.

In addition to spray coating, the coating composition of the present disclosure can be applied to a substrate using any suitable procedure such as roll coating, coil coating, curtain coating, immersion coating, meniscus coating, kiss coating, blade coating, knife coating, dip coating, slot coating, slide coating, and the like, as well as other types of premetered coating. In an embodiment where the coating is used to coat metal sheets or coils, the coating can be applied by roll coating.

A coil coating is described as the coating of a coil composed of a metal (e.g., steel or aluminum). Once coated, the coating coil is subjected to a short thermal, ultraviolet or electromagnetic curing cycle, for hardening (e.g., drying and curing) of the coating. Coil coatingsrovide coated metal (e.g., steel or aluminum) substrates that can be fabricated into formed articles, such as beverage can ends.

For any of the application techniques described above, the curing process may be performed in either discrete or combined steps. For example, substrates can be dried at ambient temperature to leave the coating composition in a largely un-crosslinked state. The coated substrates can then be heated to fully cure the compositions. In certain instances, the disclosed coating compositions may be dried and cured in one step. The cure conditions will vary depending upon the method of application and the intended end use.

In certain embodiments, the food or beverage container coating composition of the present disclosure is thermally curable. In this context, thermally curable refers to conditions of temperature and time usually used in container coating lines. The thermal curing process may be performed at any suitable temperature, including, for example, oven temperatures in the range of from 170 °C to 230 °C, and more typically from 190 °C to 220 °C, for a time period of 10 seconds to 20 minutes, and more typically for a time period of 30 seconds to 10 minutes. If the substrate to be coated is a metal coil, curing of the applied coating composition may be conducted, for example, by heating the coated metal substrate over a suitable time period to a peak metal temperature (“PMT”) of preferably greater than 180 °C. More preferably, the coated metal coil is heated for a suitable time period (e.g., 5 to 900 seconds) to a PMT of at least 200 °C. Other commercial coating application and curing methods are also envisioned, for example, electrocoating, extrusion coating, laminating, powder coating, and the like.

### EXEMPLARY EMBODIMENTS

Embodiment 1 is an aqueous food or beverage container coating composition (preferably, an aqueous food container coating composition) comprising: at least 50 wt-%, based on total resin solids, of an at least partially neutralized acid- or anhydride-functional acrylic polymer; a phenolic crosslinker (preferably, at least 1 wt-%, at least 2 wt-%, at least 5 wt-%, at least 10 wt-%, at least 15 wt-%, or at least 20 wt-%, of the phenolic crosslinker, based on total resin solids); and an aqueous liquid carrier.

Embodiment 2 is the aqueous food or beverage container coating composition of embodiment 1 comprising: at least 50 wt-%, based on total resin solids, of an at least partially neutralized acid- or anhydride-functional organic-solution polymerized acrylic polymer, wherein: the acrylic polymer is hydroxyl-functional; the acrylic polymer has a calculated acid number of less than 60 mg KOH per gram resin; and the acrylic polymer is self-dispersible in water; a phenolic crosslinker (preferably, at least 1 wt-%, at least 2 wt-%, at least 5 wt-%, at least 10 wt-%, at least 15 wt-%, or at least 20 wt-%, of the phenolic crosslinker, based on total resin solids); and an aqueous liquid carrier; wherein the coating composition is storage stable for at least 2 months at ambient temperature, not in direct sunlight, without any phase separation as determined by the unaided human eye.

Embodiment 3 is the aqueous food or beverage container coating composition of embodiment 1 comprising: at least 50 wt-%, based on total resin solids, of an at least partially neutralized acid- or anhydride-functional organic-solution polymerized acrylic polymer, wherein: the acrylic polymer is hydroxyl-functional; the acrylic polymer has a calculated acid number of less than 60 mg KOH per gram resin; and the acrylic polymer is self-dispersible in water; at least 5 wt-% phenolic crosslinker (preferably, at least 10 wt-%, at least 15 wt-%, or at least 20 wt-%, of the phenolic crosslinker), based on total resin solids; and an aqueous liquid carrier.

Embodiment 4 is the aqueous food or beverage container coating composition of embodiment 1 comprising: at least 50 wt-%, based on total resin solids, of an acrylic polymer prepared from two or more at least partially neutralized acid- or anhydride-functional organic-solution polymerized acrylic prepolymers, wherein: at least one acrylic prepolymer is hydroxyl-functional; each of the two or more acrylic prepolymers has a calculated acid number of less than 60 mg KOH per gram resin; and each of the two or more acrylic prepolymers is self-dispersible in water; a phenolic crosslinker (preferably, at least 1 wt-%, at least 2 wt-%, at least 5 wt-%, at least 10 wt-%, at least 15 wt-%, or at least 20 wt-%, of the phenolic crosslinker, based on total resin solids); and an aqueous liquid carrier; wherein the coating composition is storage stable for at least 2 months at ambient temperature, not in direct sunlight, without any phase separation as determined by the unaided human eye.

Embodiment 5 is the aqueous food or beverage container coating composition of embodiment 1 comprising: at least 50 wt-%, based on total resin solids, of an acrylic polymer prepared from two or more at least partially neutralized acid- or anhydride-functional organic-solution polymerized acrylic prepolymers, wherein: at least one acrylic prepolymer is hydroxyl-functional; each of the two or more acrylic prepolymers has a calculated acid number of less than 60 mg KOH per gram resin; and each of the two or more acrylic prepolymers is self-dispersible in water; at least 5 wt-% of a phenolic crosslinker (preferably, at least 10 wt-%, at least 15 wt-%, or at least 20 wt-%, of the phenolic crosslinker), based on total resin solids; and an aqueous liquid carrier.

Embodiment 6 is the aqueous food container coating composition of embodiment 1 comprising: at least 50 wt-%, based on total resin solids, of an at least partially neutralized acid- or anhydride-functional organic-solution polymerized acrylic polymer, wherein: the acrylic polymer is hydroxyl-functional; the acrylic polymer has a calculated acid number of less than 60 mg KOH per gram resin; and the acrylic polymer is self-dispersible in water; at least 20 wt-% of a phenolic crosslinker, based on total resin solids; and an aqueous liquid carrier; wherein the coating composition includes 20 wt-% to 40 wt-% of total solids, based on the total weight of the composition, and is storage stable for at least 2 months, at ambient temperature without any phase separation as determined by the unaided human eye.

Embodiment 7 is the coating composition of any of the preceding embodiments comprising up to 50 wt-%, up to 40 wt-%, up to 30 wt-%, up to 20 wt-%, or up to 10 wt-% of the phenolic crosslinker, based on total resin solids.

Embodiment 8 is the coating composition of any of the preceding embodiments, wherein the phenolic crosslinker comprises one or more resole phenolic resins. In certain embodiments, the one or more phenolic resins include a butylated resole phenolic resin In certain embodiments, the one or more phenolic resins includes a cresol-based phenolic resin.

Embodiment 9 is the coating composition of any of the preceding embodiments, wherein the aqueous liquid carrier comprises at least 50 wt-% water based on the total weight of the liquid carrier.

Embodiment 10 is the coating composition of any of the preceding embodiments, wherein the aqueous liquid carrier comprises at least 50 wt-% one or more organic solvents, based on the total weight of the liquid carrier.

Embodiment 11 is the coating composition of any of the preceding embodiments, wherein the organic solvents of the aqueous liquid carrier comprise ethylene glycol monobutyl ether, ethylene glycol monohexyl ether, diethylene glycol monoethyl ether, isopropanol, butanol, or combinations thereof.

Embodiment 12 is the coating composition of any of the preceding embodiments comprising at least 0.1 wt-%, at least 0.5 wt-%, at least 1 wt-%, or at least 5 wt-% of one or more organic solvents, based on the total weight of the coating composition.

Embodiment 13 is the coating composition of any of the preceding embodiments comprising no more than 22 wt-%, or no more than 20 wt-% of one or more organic solvents, based on the total weight of the coating composition.

Embodiment 14 is the coating composition of any of the preceding embodiments comprising at least 40 wt-%, or at least 50 wt-% water, based on the total weight of the coating composition.

Embodiment 15 is the coating composition of any of the preceding embodiments comprising no more than 60 wt-%, or no more than 55 wt-% water, based on the total weight of the coating composition.

Embodiment 16 is the coating composition of any of the preceding embodiments comprising at least 18 wt-%, at least 20 wt-%, at least 22 wt-%, at least 25 wt-%, or at least 28 wt-% total solids, based on the total weight of the composition.

Embodiment 17 is the coating composition of any of the preceding embodiments comprising up to 40 wt-%, up to 38 wt-%, up to 36 wt-%, up to 34 wt-%, up to 32 wt-%, up to 30 wt-%, up to 28 wt-%, up to 26 wt-%, up to 24 wt-%, or up to 22 wt-% total solids, based on the total weight of the composition.

Embodiment 18 is the coating composition of any of the preceding embodiments which has a viscosity of up to 300 centipoise, or up to 200 centipoise, measured using a viscometer (e.g., a Brookfield viscometer).

Embodiment 19 is the coating composition of any of the preceding embodiments which has a viscosity of at least 100 centipoise, measured using a viscometer (e.g., a Brookfield viscometer).

Embodiment 20 is the coating composition of embodiments 1, 3, or 5 through 19 (as dependent on embodiments 1, 3, or 5), which is storage stable for at least 2 months, at ambient temperature, not in direct sunlight, without any phase separation as determined by the unaided human eye.

Embodiment 21 is the coating composition of any of the preceding embodiments, which is storage stable for at least 3 months, at least 4 months, or at least 6 months, at ambient temperature, not in direct sunlight, without any phase separation as determined by the unaided human eye.

Embodiment 22 is the coating composition of embodiment 20 or 21, which is storage stable for at least 6 months, at ambient temperature without any phase separation as determined by the unaided human eye.

Embodiment 23 is the coating composition of any of the preceding embodiments which has a pH of at least 7.5, or at least 8.0.

Embodiment 24 is the coating composition of any of the preceding embodiments further comprising one or more optional ingredients.

Embodiment 25 is the coating composition of embodiment 24, wherein the optional ingredients comprise catalysts, dyes, pigments (e.g., TiO₂, carbon black), anti-staining agents (e.g., ZnO), toners, extenders, fillers, lubricants, anticorrosion agents, flow-control agents, thixotropic agents, dispersing agents (e.g., wax dispersants), antioxidants, adhesion promoters, light stabilizers, curing agents, novolac phenolic resins, surfactants, or mixtures thereof.

Embodiment 26 is the coating composition of embodiment 25, wherein the additives comprise TiO₂ and optionally carbon black.

Embodiment 27 is the coating composition of any of the preceding embodiments comprising at least 0.01 wt-%, at least 0.1 wt-%, at least 0.5 wt-%, or at least 1 wt-% surfactant (polymeric or small molecule surfactant), based on the total weight of total resin solids, if any surfactant is used.

Embodiment 28 is the coating composition of any of the preceding embodiments comprising no more than 5 wt-%, no more than 2 wt-%, no more than 1 wt-%, or no more than 0.5 wt-% surfactant (polymeric or small molecule surfactant), based on the total weight of total resin solids. In certain embodiments, this includes no surfactant.

Embodiment 29 is the coating composition of any of the preceding embodiments comprising at least 55 wt-%, or at least 60 wt-% of the acrylic polymer, based on total resin solids.

Embodiment 30 is the coating composition of any of the preceding embodiments comprising up to 99 wt-%, up to 95 wt-%, up to 90 wt-%, up to 85 wt-%, or up to 80 wt-% of the acrylic polymer, based on total resin solids.

Embodiment 31 is the coating composition of any of the preceding embodiments, wherein the acrylic polymer is a single-stage polymer.

Embodiment 32 is the coating composition of any of embodiments 1, 2, 3, or 6 through 31 (as dependent on embodiments 1, 2, or 3), wherein the acrylic polymer is a copolymer of two or more prepolymers.

Embodiment 33 is the coating composition of embodiments 4, 5, or 32, wherein each of the two or more prepolymers is a hydroxyl-functional prepolymer.

Embodiment 34 is the coating composition of embodiments 4, 5, 32, or 33, wherein all the prepolymers have an acid number within ±10 KOH per gram resin.

Embodiment 35 is the coating composition of embodiment 4, 5, or 32 through 34, wherein, at least one, preferably each, prepolymer has a calculated glass transition temperature (Tg) of at least 35 °C, at least 40 °C, at least 45 °C, or at least 50 °C (and in certain embodiments up to 95 °C).

Embodiment 36 is the coating composition of any of the preceding embodiments, wherein the acrylic polymer (prior to cure) has a single glass transition temperature, measured using DSC.

Embodiment 37 is the coating composition of any of the preceding embodiments, wherein the acrylic polymer has a calculated (aggregate of all monomers) Tg of at least 35 °C, at least 40 °C, at least 45 °C, or at least 50 °C (and in certain embodiments up to 95 °C). Embodiment 38 is the coating composition of any of the preceding embodiments, wherein the acrylic polymer, and/or at least one, preferably each, acrylic prepolymer if used to form the acrylic polymer, has a number average molecular weight (Mn) of at least 6,000 Da, at least 8,000 Da, at least 10,000 Da, or at least 12,000 Da, as determined using gel permeation chromatography (GPC) and a series of polystyrene standards with different molecular weights.

Embodiment 39 is the coating composition of any of the preceding embodiments, wherein the acrylic polymer, and/or at least one, preferably each, acrylic prepolymer if used to form the acrylic polymer, has a Mn of up to 35,000 Da, up to 30,000 Da, up to 28,000 Da, or up to 25,000 Da, as determined using GPC and a series of polystyrene standards with different molecular weights.

Embodiment 40 is the coating composition of any of the preceding embodiments, wherein the acrylic polymer, and/or at least one, preferably each, acrylic prepolymer if used to form the acrylic polymer, has a calculated acid number of less than 50 mg, less than 40 mg, or less than 35 mg KOH per gram resin.

Embodiment 41 is the coating composition of any of the preceding embodiments, wherein the acrylic polymer, and/or at least one, preferably each, acrylic prepolymer if used to form the acrylic polymer, has a calculated acid number of at least 8 mg, at least 10 mg, at least 20 mg, at least 30 mg, or at least 32 mg KOH per gram resin.

Embodiment 42 is the coating composition of any of the preceding embodiments, wherein the acrylic polymer, and/or at least one, preferably each, acrylic prepolymer if used to form the acrylic polymer, has a calculated hydroxyl number of less than 120 mg, less than 60 mg, or less than 30 mg KOH per gram resin.

Embodiment 43 is the coating composition of any of the preceding embodiments, wherein the acrylic polymer, and/or at least one, preferably each, acrylic prepolymer if used to form the acrylic polymer, has a calculated hydroxyl number of at least 5 mg, at least 15 mg, or at least 28 mg KOH per gram resin.

Embodiment 44 is the coating composition of any of the preceding embodiments, wherein the acrylic polymer has a degree of neutralization of no more than 200%, no more than 150%, no more than 100%, no more than 80%, or no more than 60%, based on an acid number of at least 8 mg KOH per gram resin.

Embodiment 45 is the coating composition of any of the preceding embodiments, wherein the acrylic polymer has a degree of neutralization of no more than 150%, no more than 100%, no more than 80%, or no more than 60%, based on an acid number of at least 15 mg KOH per gram resin.

Embodiment 46 is the coating composition of any of the preceding embodiments, wherein the acrylic polymer has a degree of neutralization of no more than 100%, no more than 80%, or no more than 60%, based on an acid number of at least 20 mg KOH per gram resin.

Embodiment 47 is the coating composition of any of the preceding embodiments, wherein the acrylic polymer has a degree of neutralization of no more than 80%, or no more than 60%, based on an acid number of at least 32 mg KOH per gram resin

Embodiment 48 is the coating composition of any of the preceding embodiments, wherein the acrylic polymer has a degree of neutralization of no more than 100%, no more than 80%, or no more than 60%, based on an acid number of at least 40 mg KOH gram resin.

Embodiment 49 is the coating composition of any of the preceding embodiments, wherein the acrylic polymer has a degree of neutralization of at least 20%, at least 30%, or at least 40%, based on an acid number of at least 50 mg KOH gram resin.

Embodiment 50 is the coating composition of any of the preceding embodiments, wherein the acrylic polymer comprises interpolymerized acid-functional monomers and optionally hydroxyl-functional monomers.

Embodiment 51 is the coating composition of embodiment 50, wherein the acid-functional monomers comprise (meth)acrylic acid, crotonic acid, unsaturated dicarboxylic acid or anhydride (e.g., maleic acid, fumaric acid, itaconic acid, and maleic anhydride), phosphoric acid (meth)acrylate, phosphonic acid (meth)acrylate, monoalkyl maleate or anhydride, or combinations thereof.

Embodiment 52 is the coating composition of embodiment 51, wherein the acid-functional monomers comprise (meth)acrylic acid.

Embodiment 53 is the coating composition of any one of embodiments 50 through 52, wherein the hydroxyl-functional monomers comprise hydroxyethyl (meth)acrylate, hydroxypropyl (meth)acrylate, hydroxybutyl (meth)acrylate, mono- or di-ester of unsaturated dicarboxylic acid (e.g., maleic acid, fumaric acid, or itaconic acid), in which at least one of the esterified groups contains a hydroxyl group (e.g., mono (2-hydroxyethyl) maleate, 2-hydroxyethylbutyl maleate), or combinations thereof.

Embodiment 54 is the coating composition of embodiment 53, wherein the hydroxyl-functional monomers comprise hydroxyethyl (meth)acrylate, hydroxypropyl (meth)acrylate, hydroxybutyl (meth)acrylate, or combinations thereof.

Embodiment 55 is the coating composition of any one of embodiments 50 through 54, wherein the acrylic polymer further comprises interpolymerized secondary monomers.

Embodiment 56 is the coating composition of embodiment 55, wherein the secondary monomers comprise (meth)acrylate monomers (e.g., methyl (meth)acrylate, ethyl (meth)acrylate, butyl (meth)acrylate, 2-ethylhexyl (meth)acrylate); difunctional (meth)acrylate monomers (e.g., 1,4-butanediol di(meth)acrylate, 1,6-hexanediol di(meth)acrylate, allyl (meth)acrylate); (meth)acrylamide and derivatives thereof (e.g., methyol acrylamide); vinyl aromatic monomers (e.g., styrene and divinyl benzene), cyclohexyl (meth)acrylate, benzyl (meth)acrylate, or combinations thereof.

Embodiment 57 is the coating composition of embodiment 56, wherein the secondary monomers comprise methyl (meth)acrylate, ethyl (meth)acrylate, butyl (meth)acrylate, 2-ethylhexyl (meth)acrylate, styrene, cyclohexyl (meth)acrylate, benzyl (meth)acrylate, or combinations thereof.

Embodiment 58 is the coating composition of embodiment 57, wherein the secondary monomers comprise methyl (meth)acrylate, ethyl (meth)acrylate, butyl (meth)acrylate, 2-ethylhexyl (meth)acrylate, cyclohexyl (meth)acrylate, benzyl (meth)acrylate, or combinations thereof. Embodiment 59 is the coating composition of any of embodiments 50 through 58, wherein the acrylic polymer comprises at least 1.0 wt-%, at least 1.5 wt-%, at least 2.0 wt-%, at least 2.5 wt-%, at least 3.0 wt-%, at least 3.5 wt-%, or at least 4.0 wt-% interpolymerized acid-functional monomers, based on the total weight of the monomers used in the polymerization reaction.

Embodiment 60 is the coating composition of any of embodiments 50 through 59, wherein the acrylic polymer comprises no more than 8 wt-%, no more than 7 wt-%, no more than 6 wt-%, or no more than 5 wt-% interpolymerized acid-functional monomers, based on the total weight of the monomers used in the polymerization reaction.

Embodiment 61 is the coating composition of any of embodiments 50 through 60, wherein the acrylic polymer comprises at least 1.0 wt-%, at least 1.5 wt-%, at least 2.0 wt-%, at least 2.5 wt-%, at least 3.0 wt-%, at least 3.5 wt-%, at least 4.0 wt-%, at least 4.5 wt-%, at least 5.0 wt-%, or at least 5.5 wt-% interpolymerized hydroxyl-functional monomers, based on the total weight of the monomers used in the polymerization reaction.

Embodiment 62 is the coating composition of any of embodiments 50 through 61, wherein the acrylic polymer comprises no more than 35 wt-%, no more than 30 wt-%, no more than 25 wt-%, no more than 20 wt-%, no more than 15 wt-%, no more than 10 wt-%, or no more than 8 wt-% interpolymerized hydroxyl-functional monomers, based on the total weight of the monomers, used in the polymerization reaction.

Embodiment 63 is the coating composition of any of embodiments 55 through 62, wherein the acrylic polymer comprises at least 50 wt-%, at least 55 wt-%, at least 60 wt-%, at least 65 wt-%, at least 70 wt-%, at least 75 wt-%, at least 80 wt-%, or at least 85 wt-% interpolymerized secondary monomers, based on the total weight of the monomers used in the polymerization reaction.

Embodiment 64 is the coating composition of any of embodiments 55 through 63, wherein the acrylic polymer comprises no more than 98 wt-%, no more than 96 wt-%, or no more than 90 wt-% interpolymerized secondary monomers, based on the total weight of the monomers, used in the polymerization reaction.

Embodiment 65 is the coating composition of any one of embodiments 50 through 64, wherein the acrylic polymer comprises no more than 40 wt-%, no more than 30 wt-%, no more than 20 wt-%, or no more than 10 wt-% interpolymerized styrene monomers based on the total weight of the monomers used in the polymerization reaction.

Embodiment 66 is the coating composition of embodiment 65, wherein the acrylic polymer is styrene-free.

Embodiment 67 is the coating composition of any one of embodiments 50 through 66, wherein the acrylic polymer does not include interpolymerized vinyl chloride monomers.

Embodiment 68 is the coating composition of any preceding embodiments, wherein the acrylic polymer is halogen-free.

Embodiment 69 is the coating composition of any one of embodiments 50 through 68, wherein the acrylic polymer consists of interpolymerized (meth)acrylic acid, (meth)acrylate monomers, or combinations thereof.

Embodiment 70 is the coating composition of any of the preceding embodiments, wherein the acrylic polymer is in the form of particles having a particle size distribution having one, two, or all of the following: a D10 of less than 0.15 micrometer, a D50 of less than 0.25 micrometer, a D90 of less than 0.50 micrometer.

Embodiment 71 is the coating composition of any of the preceding embodiments, wherein the acrylic polymer is in the form of particles having a particle size distribution having one, two, or all of the following: a D10 of at least 0.07 micrometer, a D50 of at least 0.10 micrometer, a D90 of at least 0.12 micrometer.

Embodiment 72 is the coating composition of any of the preceding embodiments, which is substantially free of each of bisphenol A, bisphenol F, and bisphenol S.

Embodiment 73 is the coating composition of any of the preceding embodiments, which is substantially free of all bisphenol compounds not including tetramethyl bisphenol F (TMBPF).

Embodiment 74 is the coating composition of any of the preceding embodiments, which forms a cured coating that includes less than 50 ppm, less than 25 ppm, less than 10 ppm, or less than 1 ppm, extractables, if any, when tested pursuant to the Global Extraction Test in the Test Methods.

Embodiment 75 is the coating composition of any of the preceding embodiments, wherein when applied on a tin plate panel having a thickness of 0.0208 mm in an amount sufficient to achieve a dry film weight of 4-5 mg/in², after exposure to a temperature of 425 °F (218 °C) for 3.5 minutes, provides a cured coating having one or more of the following properties: an adhesion rating of at least 4B (i.e., 4B or 5B), when tested pursuant to the Adhesion Test in the Test Methods; a double rub rating of at least 30 or at least 50 when tested pursuant to the Solvent Resistance Test in the Test Methods (ASTM D 5402-93 for MEK rubs); or displaying no crazing when tested pursuant to the Reverse Impact Test (ASTM D2794-93) in the Test Methods.

Embodiment 76 is the coating composition of any of the preceding embodiments, wherein a cured coating has a single glass transition temperature, measured using DSC, of greater than 50 °C (which is the temperature of the hot room for food cans).

Embodiment 77 is the coating composition of any of the preceding embodiments which is an interior (food or beverage) container coating composition.

Embodiment 78 is the coating composition of any of the preceding embodiments which is a food container coating composition.

Embodiment 79 is the coating composition of embodiment 78 which is an inside spray two-piece food D&I can coating composition.

Embodiment 80 is an at least partially neutralized acid- or anhydride-functional organic-solution polymerized acrylic polymer of the coating composition of any one of the preceding embodiments.

Embodiment 81 is an at least partially neutralized acid- or anhydride-functional organic-solution polymerized acrylic polymer comprising interpolymerized monomers comprising (meth)acrylic acid monomers; wherein the acrylic polymer is hydroxyl-functional, has a calculated acid number of less than 60 mg KOH per gram resin, is self-dispersible in water, and is crosslinked with at least 5 wt-% resole phenolic crosslinker, based on total resin solids.

Embodiment 82 is the polymer of embodiment 81 further comprising interpolymerized monomers comprising a (C1-C12) (meth)acrylate monomer, (C1-C8) (meth)acrylate monomer, a (C1-C4) (meth)acrylate monomer, or a C4 (meth)acrylate monomer.

Embodiment 83 is the polymer of embodiment 82, wherein the interpolymerized monomers comprise a (C1-C12) (meth)acrylate monomer, (C1-C8) acrylate monomer, a (C1-C4) acrylate monomer, or a C4 acrylate monomer.

Embodiment 84 is the polymer of any one of embodiments 80 through 83 further comprising interpolymerized monomers comprising styrene.

Embodiment 85 is the polymer of any one of embodiments 80 through 83, which is styrene-free.

Embodiment 86 is the polymer of any one of embodiments 80 through 85, which is halogen-free.

Embodiment 87 is the polymer of any one of embodiments 80 through 86, which is crosslinked with at least 10 wt-%, at least 15 wt-%, or at least 20 wt-% of the resole phenolic crosslinker, based on total resin solids.

Embodiment 88 is the polymer of any one of embodiments 80 through 87, which is crosslinked with up to 50 wt-%, up to 40 wt-%, up to 30 wt-%, up to 20 wt-%, or up to 10 wt-% of the resole phenolic crosslinker, based on total resin solids.

Embodiment 89 is the polymer of any one of embodiments 80 through 88, wherein the acrylic polymer (prior to cure) has a single glass transition temperature, measured using DSC.

Embodiment 90 is the polymer of any one of embodiments 80 through 89, wherein the acrylic polymer has a calculated (aggregate of all monomers) glass transition temperature of at least 35 °C.

Embodiment 91 is the polymer of embodiments 90, wherein the acrylic polymer has a calculated (aggregate of all monomers) glass transition temperature of at least 40 °C.

Embodiment 92 is the polymer of embodiments 91, wherein the acrylic polymer has a calculated (aggregate of all monomers) glass transition temperature of at least 45 °C.

Embodiment 93 is the polymer of embodiments 92, wherein the acrylic polymer has a calculated (aggregate of all monomers) glass transition temperature of at least 50 °C.

Embodiment 94 is the polymer of any one of embodiments 80 through 93, wherein the acrylic polymer has a calculated (aggregate of all monomers) glass transition temperature of up to 95 °C.

Embodiment 95 is the polymer of any one of embodiments 80 through 94, which has a Mn of at least 6,000 Da, at least 8,000 Da, at least 10,000 Da, or at least 12,000 Da, as determined using GPC and a series of polystyrene standards with different molecular weights.

Embodiment 96 is the polymer of any one of embodiments 80 through 95, which has a Mn of up to 35,000 Da, up to 30,000 Da, up to 28,000 Da, or up to 25,000 Da, as determined using GPC and a polystyrene standard.

Embodiment 97 is the polymer of any one of embodiments 80 through 96, which has a calculated acid number of less than 50 mg, less than 40 mg, or less than 35 mg KOH per gram resin.

Embodiment 98 is the polymer of any one of embodiments 80 through 97, which has a calculated acid number of at least 8 mg, at least 10 mg, at least 20 mg, at least 30 mg, or at least 32 mg KOH per gram resin.

Embodiment 99 is the polymer of any one of embodiments 80 through 98, which has a calculated hydroxyl number of less than 120 mg, less than 60 mg, or less than 30 mg KOH per gram resin,

Embodiment 100 is the polymer of any one of embodiments 80 through 99, which has a calculated hydroxyl number of at least 5 mg, at least 15 mg, or at least 28 mg KOH per gram resin.

Embodiment 101 is a coated metal substrate comprising a metal substrate having a cured adherent coating disposed on at least a portion of a surface thereof, wherein the coating is formed from an aqueous coating composition of any one of embodiments 1 through 79.

Embodiment 102 is the coated metal substrate of embodiment 101, which has an average coating weight of 0.5 mg/in² (0.08 mg/cm²) to 0.7 mg/in² (0.1 mg/cm²).

Embodiment 103 is the coated metal substrate of embodiment 102, which forms a beverage can.

Embodiment 104 is the coated metal substrate of embodiment 101, which has an average coating weight of 4 mg/in² (0.62 mg/cm²) to 5 mg/in² (0.78 mg/cm²).

Embodiment 105 is the coated metal substrate of embodiment 104, which forms a food can.

Embodiment 106 is the coated metal substrate of any one of embodiments 101 through 105, wherein the metal substrate comprises a pre-treated or primed substrate.

Embodiment 107 is a coated metal substrate comprising a metal substrate having a cured adherent coating disposed on at least a portion of a surface thereof, wherein the coating is formed from an aqueous food container coating composition comprising: at least 50 wt-%, based on total resin solids, of an at least partially neutralized acid- or anhydride-functional organic-solution polymerized acrylic polymer, wherein the acrylic polymer is hydroxyl-functional, has a calculated acid number of less than 60 mg KOH per gram resin, and is self-dispersible in water, at least 20 wt-% of crosslinker including one or more phenolic crosslinkers, based on total resin solids; and an aqueous liquid carrier.

Embodiment 108 is the coated metal substrate of embodiment 107, wherein the coating composition is storage stable for at least 2 months, at least 3 months, at least 4 months, or at least 6 months, at ambient temperature (and not in direct sunlight) without any phase separation as determined by the unaided human eye.

Embodiment 109 is the coated metal substrate of embodiment 107 or 108, wherein the phenolic crosslinker comprises a resole phenolic resin.

Embodiment 110 is the coated metal substrate of any one of embodiments 107 through 109, wherein the polymer comprises interpolymerized monomers comprising (meth)acrylic acid, and optionally hydroxyl-functional monomers, particularly hydroxyl-functional (meth)acrylate monomers such as hydroxypropyl (meth)acrylate monomers.

Embodiment 111 is the coated metal substrate of embodiment 110, wherein the polymer further comprises interpolymerized monomers comprising a (C1-C12) (meth)acrylate monomer, (C1-C8) (meth)acrylate monomer, a (C1-C4) (meth)acrylate monomer, or a C4 (meth)acrylate monomer.

Embodiment 112 is the coated metal substrate of any one of embodiments 107 through 111, wherein the polymer further comprises interpolymerized monomers comprising styrene.

Embodiment 113 is the coated metal substrate of any one of embodiments 107 through 112, wherein the cured coating has an average coating weight of 4 mg/in² (0.62 mg/cm²) to 5 mg/in² (0.78 mg/cm²).

Embodiment 114 is the coated metal substrate of embodiment 113, which forms a food can.

Embodiment 115 is the coated metal substrate of any one of embodiments 107 through 114, wherein the metal substrate comprises a pre-treated or primed substrate.

Embodiment 116 is a metal packaging comprising a coated metal substrate of any one of embodiments 101 through 115.

Embodiment 117 is the metal packaging of embodiment 116 comprising a metal packaging container or a portion thereof.

Embodiment 118 is the metal packaging of embodiment 117 comprising a can or a can end.

Embodiment 119 is the metal packaging of any one of embodiments 116 through 118, wherein the coated metal substrate comprises a coated surface that forms an interior surface of a container body.

Embodiment 120 is the metal packaging of embodiment 119, wherein the container is filled with a food or beverage product.

Embodiment 121 is the metal packaging of any one of embodiments 116 through 120, wherein the metal substrate has a thickness of 0.125 mm to 0.635 mm, preferably, 0.0082 in (0.21 mm).

Embodiment 122 is the metal packaging of embodiment 120 or 121, which is filled with a food product.

Embodiment 123 is a metal packaging comprising a coated metal substrate comprising a metal substrate having a cured adherent coating disposed on at least a portion of a surface thereof, wherein the coating is formed from an aqueous food container coating composition comprising: at least 50 wt-%, based on total resin solids, of an at least partially neutralized acid- or anhydride-functional organic-solution polymerized acrylic polymer, wherein the acrylic polymer is hydroxyl-functional, has a calculated acid number of less than 60 mg KOH per gram resin, and is self-dispersible in water; at least 20 wt-% of crosslinker including one or more phenolic crosslinkers, based on total resin solids; and an aqueous liquid carrier.

Embodiment 124 is the metal packaging of embodiment 123, wherein the coating composition is storage stable for at least 2 months, at least 3 months, at least 4 months, or at least 6 months at ambient temperature (and not in direct sunlight) without any phase separation as determined by the unaided human eye.

Embodiment 125 is the metal packaging of embodiment 123 or 124, wherein the phenolic crosslinker comprises a resole phenolic resin.

Embodiment 126 is the metal packaging of any one of embodiments 123 through 125, wherein the polymer comprises interpolymerized monomers comprising (meth)acrylic acid monomers. In certain embodiments, the interpolymerized monomers further include a hydroxypropyl (meth)acrylate monomer and a (C1-C12) (meth)acrylate monomer.

Embodiment 127 is the metal packaging of any one of embodiments 123 through 126, wherein the polymer further comprises interpolymerized monomers comprising styrene.

Embodiment 128 is the metal packaging of any one of embodiments 123 through 127, wherein the cured coating has an average coating weight of 4 mg/in² (0.62 mg/cm²) to 5 mg/in² (0.78 mg/cm²).

Embodiment 129 is the metal packaging of embodiment 128, which forms a food can.

Embodiment 130 is the metal packaging of any one of embodiments 123 through 129, wherein the metal substrate comprises a pre-treated or primed substrate.

Embodiment 131 is the method of forming an aqueous coating composition of any one of embodiments 1 through 86, the method comprising: providing (e.g., forming) a first mixture comprising an ethylenically unsaturated monomer component (that includes at least (meth)acrylic acid monomers, optionally (meth)acrylate monomers, and an organic solvent; polymerizing (e.g., free-radically polymerizing) the ethylenically unsaturated monomer component in the organic solvent to form a polymer mixture and an acid- or anhydride functional polymer, the acid- or anhydride-functional acrylic polymer having a calculated acid number of less than 60 mg KOH per gram polymer; adding a fugitive base to the polymer mixture to at least partially neutralize the acid- or anhydride-functional acrylic polymer to form an at least partially neutralized acid- or anhydride functional acrylic polymer and a second mixture comprising the at least partially neutralized acid- or anhydride functional acrylic polymer; and combining the second mixture with water (the water can be added simultaneously with the fugitive base to the polymer mixture, but preferably the fugitive base is added before the water) to form an aqueous coating composition that includes (i) at least 50 wt-%, based on total resin solids, of the acrylic polymer and (ii) at least 5 wt-%, based on total resin solids, of a phenolic crosslinker; wherein the aqueous coating composition is storage stable for at least 2 months at ambient temperature (and not in direct sunlight) without any phase separation as determined by the unaided human eye.

Embodiment 132 is the method of embodiment 131, wherein the first mixture comprises the phenolic crosslinker.

Embodiment 133 is the method of embodiment 131, wherein the method further comprises adding the phenolic crosslinker to the second mixture.

Embodiment 134 is the method of embodiments 131 through 133, wherein the method further comprises agitating the second mixture. Embodiment 135 is the method of embodiment 133 or 134, where in the second mixture is agitated after adding the phenolic crosslinker.

Embodiment 136 is the method of any one of embodiments 131 through 135, wherein combining the polymer mixture with water comprises adding water to the polymer mixture.

Embodiment 137 is the method of embodiment 136, wherein adding water to the mixture occurs over a period of one hour.

Embodiment 138 is the method of any one of embodiments 131 through 137, wherein the fugitive base used for neutralization comprises ammonia, ammonium hydroxide, an amine, or a combination thereof.

Embodiment 139 is the method of any one of embodiments 131 through 138, wherein the ethylenically unsaturated component comprises (meth)acrylic acid monomers and optionally hydroxyl-functional monomers, particularly hydroxyl-functional (meth)acrylate monomers such as hydroxypropyl (meth)acrylate monomers.

Embodiment 140 is the method of embodiment 139, wherein the ethylenically unsaturated component further comprises a (C1-C12) (meth)acrylate monomer.

Embodiment 141 is the method of embodiment 139 or 140, wherein the ethylenically unsaturated component comprises styrene.

Embodiment 142 is the method of any one of embodiments 131 through 141, wherein the aqueous coating composition comprises at least 10 wt-%, at least 15 wt-%, or at least 20 wt-% of the resole phenolic crosslinker, based on total resin solids.

Embodiment 143 is the method of any one of embodiments 131 through 142, wherein the aqueous coating composition comprises up to 50 wt-%, up to 40 wt-%, up to 30 wt-%, up to 20 wt-%, or up to 10 wt-% of the resole phenolic crosslinker, based on total resin solids.

Embodiment 144 is the method of any one of embodiments 131 through 140 or 141 through 143, wherein the acrylic polymer is styrene-free, halogen-free, or both.

Embodiment 145 is the method of any one of embodiments 131 through 144, wherein the acrylic polymer has a Mn of at least 6,000 Da, at least 8,000 Da, at least 10,000 Da, or at least 12,000 Da, as determined using GPC and a series of polystyrene standards with different molecular weights, and preferably has a Mn of up to 35,000 Da, up to 30,000 Da, up to 28,000 Da, or up to 25,000 Da, as determined using GPC and a polystyrene standard.

Embodiment 146 is the method of any one of embodiments 131 through 145, wherein the acrylic polymer has a calculated acid number of less than 50 mg, less than 40 mg, or less than 35 mg KOH per gram resin, and preferably has a calculated acid number of at least 8 mg, at least 10 mg, at least 20 mg, at least 30 mg, or at least 32 mg KOH per gram resin.

Embodiment 147 is the method of any one of embodiments 131 through 146, wherein the acrylic polymer has a calculated hydroxyl number of less than 120 mg, less than 60 mg, or less than 30 mg KOH per gram resin, and preferably has a calculated hydroxyl number of at least 5 mg, at least 15 mg, or at least 28 mg KOH per gram resin.

Embodiment 148 is a method of coating a food or beverage container, the method comprising: providing a food or beverage container coating composition of any one of embodiments 1 through 86; causing the coating composition to be applied to at least a portion of a metal substrate (preferably applying the coating composition to at least a portion of a metal substrate) prior to or after forming the metal substrate into a food or beverage container or portion thereof; and thermally curing the coating composition to form a cured coating.

Embodiment 149 is the method of embodiment 148, wherein the substrate is a flat substrate, and the method further comprises forming the flat metal substrate into at least a portion of a food or beverage container after thermally curing the coating composition.

Embodiment 150 is the method of embodiment 148, wherein the metal substrate is in the form of at least a portion of a preformed food or beverage container.

Embodiment 151 is the method of any one of embodiments 148 through 150, wherein applying the coating composition comprises spraying the coating composition onto the metal substrate.

Embodiment 152 is the method of embodiment 151 wherein the metal substrate is in the form of a preformed food or beverage can having a sidewall and a bottom end, and spraying comprises spraying an interior surface of the sidewall and bottom end.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, MO; Hexion, Columbus, OH; SBHPP, Novi, MI; Allnex, Kalamazo, MI; Dow, Midland, MI; or may be synthesized by conventional methods. The following abbreviations may be used in the following examples: Mn=number average molecular weight; ppm=parts per million; mL=milliliter; L=liter; m=meter, mm=millimeter, cm=centimeter, μm=micrometer, kg=kilogram, g=gram, min=minute, s=second, h=hour, °C.=degrees Celsius, °F=degrees Fahrenheit, MPa=megapascals, and N-m=Newton-meter, Mn=number average molecular weight, cps=centipoise.

In the following Examples, all glass transition temperatures were calculated, all acid numbers (AC) were calculated, and all Mn values were determined using gel permeation chromatography (GPC) and polystyrene standards. The viscosity (n) was measured according to ASTM D2196-20 using a Brookfield viscometer and according to ASTM D1200-10 using a Ford viscosity cup #4 (as further described in the Test Methods). Particle size was determined using laser diffraction particle size analyzer (Coulter Particle Size LS 13 320 with Universal Liquid Module available from Beckman Coulter, Indianapolis, IN; as further described in the Test Methods). The solid content of the phenolic resins can be found in the manufacturer's documentation.

Table 1A is a materials table giving a list of monomers and their associated acronyms, molecular weights, homopolymer Tg value, and vendor source for various monomers used in the Examples. Table 1B is a second materials table giving a list of other agents used in the Examples.

TABLE 1A
Monomers and Associated Information

| | | Tg, | Mw, | |
|---|---|---|---|---|
| Monomer | Symbol | (°C) | (g/mol) | Source |
| acrylic acid | AA | 106 | 72.06 | Sigma-Aldrich |
| methacrylic acid | MAA | 185 | 86.06 | Sigma-Aldrich |
| 2-hydroxyethyl acrylate | HEA | −15 | 116.11 | Sigma-Aldrich |
| 2-hydroxyethyl methacrylate | HEMA | 57 | 130.14 | Sigma-Aldrich |
| (i.e., hydroxyethyl | | | | |
| methacrylate) | | | | |
| 2-hydroxypropyl acrylate | HPA | −7 | 116.12 | Sigma-Aldrich |
| (i.e., hydroxypropyl acrylate) | | | | |
| 2-hydroxypropyl methacrylate | HPMA | 76 | 144.17 | Sigma-Aldrich |
| (i.e., hydroxypropyl | | | | |
| methacrylate) | | | | |
| methyl acrylate | MA | 10 | 86.09 | Sigma-Aldrich |
| methyl methacrylate | MMA | 105 | 100.12 | Sigma-Aldrich |
| ethyl acrylate | EA | −24 | 100.12 | Sigma-Aldrich |
| ethyl methacrylate | EMA | 65 | 114.14 | Sigma-Aldrich |
| n-butyl acrylate | BA | −54 | 128.17 | Sigma-Aldrich |
| n-butyl methacrylate | BMA | 20 | 142.19 | Sigma-Aldrich |
| tert-butyl acrylate | t-BA | −273 | 116.16 | Sigma-Aldrich |
| glycidyl methacrylate | GMA | 59 | 142.154 | Sigma-Aldrich |
| styrene | St | 100 | 104.15 | Sigma-Aldrich |

TABLE 1B
Materials used in the Examples and Associated Information

| Trade Name or | Chemical | | |
|---|---|---|---|
| Abbreviation | Type or Name | Application | Vendor |
| BAKELITE PF6535PF | phenolic resin | crosslinker | Hexion |
| DUREZ 34185 | phenolic resin | crosslinker | Sbhpp |
| PHENODUR PR612 | phenolic resin | crosslinker | Allnex |
| PHENODUR PR616 | phenolic resin | crosslinker | Allnex |
| LUPEROX 26 | tert-butyl 2- | initiator | Alkema |
| | ethylperoxy- | | |
| | hexanoate | | |
| DMEOA | dimethyl- | organic base | Sigma-Aldrich |
| | ethanolamine | | |
| butyl cellosolve | 2-butoxyethanol | organic | Dow |
| | | solvent | |
| butanol | 1-butanol | organic | Dow |
| | | solvent | |

### Preparation of Acrylic Resins

### Example—Preparation of Acrylic-Phenolic Dispersion

### Example 1. Preparation of Acrylic-Phenolic Dispersion Comprising Acrylic Acid and Methyl Methacrylate

The Feeds in Table 2A were used in the preparation of various acrylic-phenolic dispersions (Runs 1 and 2). The acrylic polymer was made from acrylic acid, hydroxypropyl methacrylate, methyl methacrylate, styrene, and n-butyl acrylate. The resultant dispersions comprise 30% of phenolic resins, BAKELITE PF6535 LB and DUREZ 34285, based on total solids.

Feed A and 10% of Feed B (see Table 2A) were added to a 1-liter 4-neck round-bottom flask equipped with a mechanical agitator, a nitrogen inlet, a reflux condenser, and a thermocouple connected to a heating control device, and a heating device. The mixture in the flask was heated to reflux (96 °C) and maintained at reflux for 15 minutes. The remaining 90% of Feed B was charged using a piston fluid metering pump (available from Fluid Metering Inc. in Syosset, NY) to the flask over 2.5 hours while the flask was maintained at 96 °C. When the addition of Feed B was complete, Feed C was used to rinse any remaining portion of Feed B in the pump into the flask. After a 2-hour hold at 96 °C, Feed D was added into the flask. The reaction was held at 1.0 hour at 96 °C and then cooled to 72 °C. Feed E was charged into the flask over 10 minutes while the flask was held at 72 °C. Following completion of the addition of Feed E, the reaction flask was held at 72 °C for 30 minutes and then cooled to 60 °C. Feed F was charged to the flask and then the reaction flask was held for 30 minutes at 60 °C. The heating device was turned off and Feed G was charged to the flask over 2 hours while the flask was being agitated at 300 revolutions per minute (rpm). Over the 2-hour Feed G addition period, the temperature was decreased from 60 °C to around 30 °C. The resultant dispersions were discharged after stirring an additional 30 minutes at 30 °C. The products were stable white dispersions. The characteristics of the resultant dispersion are shown in Table 2B

TABLE 2A

Mass(g)

| Feed | Component | Run 1 | Run 2 |
|---|---|---|---|
| A | Butyl cellosolve | 50.8 | 50.8 |
| A | Deionized water | 7.0 | 7.0 |
| B | Acrylic acid | 3.15 | 5.33 |
| B | Hydroxypropyl methacrylate | 36.7 | 36.7 |
| B | Methyl methacrylate | 55.5 | 55.5 |
| B | Styrene | 62.9 | 62.9 |
| B | n-Butyl acrylate | 5.6 | 5.6 |
| B | LUPEROX 26 | 3.51 | 3.51 |
| B | Butyl cellosolve | 9.1 | 9.1 |
| C | Butyl cellosolve | 12.7 | 12.7 |
| C | Deionized water | 16.3 | 16.3 |
| D | LUPEROX 26 | 0.35 | 0.35 |
| E | Dimethylethanolamine | 5.83 | 6.60 |
| E | Deionized water | 19.2 | 19.2 |
| F | BAKELITE PF6535LB | 56.0 | 56.7 |
| F | DUREZ 34285 | 49.2 | 49.9 |
| G | Deionized water | 359.0 | 359.0 |

TABLE 2B

| | Run 1 | Run 2 |
|---|---|---|
| Solids (wt-%) | 29.6 | 30.0 |
| η (Brookfield; cps) | 64 | 257 |
| η (#4 Ford cup; sec) | 10.9 | 41.4 |
| AN (mg KOH/g resin) | 15.0 | 25.0 |
| pH | 10.5 | 9.7 |
| Mn (Da) | 16,140 | 20,200 |
| Particle size (μm) | 0.43 | 0.13 |

### Example 2. Preparation of Acrylic-Phenolic Dispersion Comprising Acrylic Acid and Ethyl Methacrylate

The Feeds in Table 3A were used in the preparation of various acrylic-phenolic dispersions (Runs 3-7). The acrylic polymer was made from acrylic acid, hydroxypropyl methacrylate, ethyl methacrylate, styrene, and n-butyl acrylate. The resultant dispersions comprise two phenolic resins, BAKELITE PF6535 LB and DUREZ 34285. The compositions of Runs 3 through 7 in EXAMPLE 2 were similar to that of Run 1, but methyl methacrylate (Run 1) was replaced with ethyl methacrylate in Feed B. The acid numbers were variable from 8 to 60 mg KOH/g per resin. The total phenolic resins were in the range of 5% to 40% by weight based on solid contents. The same procedure as described in Example 1 was used to prepare these dispersions. The products were stable white dispersions. The characteristics of the resultant dispersion are shown in Table 3B.

TABLE 3A

| | | Mass (g) | | | | |
|---|---|---|---|---|---|---|
| Feed | Component | Run 3 | Run 4 | Run 5 | Run 6 | Run 7 |
| A | Butyl cellosolve | 254.1 | 43.5 | 43.5 | 50.8 | 50.8 |
| A | Deionized water | 35.0 | 6.0 | 6.0 | 7.0 | 7.0 |
| B | Acrylic acid | 35.00 | 7.56 | 11.65 | 1.67 | 2.11 |
| B | Hydroxypropyl | 186.8 | 32.0 | 32.0 | 36.7 | 36.7 |
| | methacrylate | | | | | |
| B | Ethyl methacrylate | 277.7 | 47.6 | 47.6 | 55.5 | 55.5 |
| B | Styrene | 314.7 | 53.9 | 53.9 | 62.9 | 62.9 |
| B | n-Butyl acrylate | 35.0 | 6.0 | 6.0 | 5.6 | 7.0 |
| B | LUPEROX 26 | 17.87 | 3.06 | 3.06 | 3.29 | 3.33 |
| B | Butyl cellosolve | 45.6 | 7.8 | 7.8 | 9.1 | 9.1 |
| C | Butyl cellosolve | 63.6 | 10.9 | 10.9 | 12.7 | 12.7 |
| C | Deionized water | 81.6 | 14.0 | 14.0 | 16.3 | 16.3 |
| D | LUPEROX 26 | 1.78 | 0.30 | 0.30 | 0.33 | 0.33 |
| E | Dimethyl- | 28.14 | 6.08 | 6.49 | 4.13 | 5.22 |
| | ethanolamine | | | | | |
| E | Deionized water | 96.0 | 16.4 | 16.4 | 19.2 | 19.2 |
| F | BAKELITE | 280.0 | 78.1 | 80.2 | 6.8 | 32.7 |
| | PF6535LB | | | | | |
| F | DUREZ 34285 | 246.3 | 68.7 | 70.6 | 5.9 | 28.7 |
| G | Deionized water | 1,839.6 | 381.7 | 395.3 | 248.1 | 306.3 |

TABLE 3B

| | Run 3 | Run 4 | Run 5 | Run 6 | Run 7 |
|---|---|---|---|---|---|
| Solids (wt-%) | 30.6 | 30.1 | 30.6 | 30.6 | 30.5 |
| η (Brookfield; cps) | 103 | 131 | 99 | 75 | 80 |
| η (#4 Ford cup; sec) | 15.9 | 15.7 | 14.2 | 11.0 | 11.0 |
| AN (mg KOH/g resin) | 32.1 | 40.0 | 60 | 8.0 | 10.0 |
| pH | 8.9 | 8.9 | 8.0 | 11.0 | 11.1 |
| Mn (Da) | 18,750 | 15,260 | 19,750 | 19,890 | 18,060 |
| Particle size (μm) | 0.17 | 0.13 | 0.20 | 0.39 | 1.15 |

### Example 3. Preparation of Acrylic-Phenolic Dispersion Comprising Methacrylic Acid and Ethyl Methacrylate

The Feeds in Table 4A were used in the preparation of various acrylic-phenolic dispersions (Runs 8-13). The acrylic polymer was made from methacrylic acid, hydroxypropyl methacrylate, ethyl methacrylate, styrene, and n-butyl acrylate. In Runs 10 and 11, n-butyl acrylate was removed from Feed B. The resultant dispersion comprises two phenolic resins, BAKELITE PF6535 and DUREZ 34285. The compositions of Runs 8 through 13 in EXAMPLE 3 were similar to those of Run 3 but acrylic acid (Run 3) was replaced with methacrylic acid in Feed B. The acid number was in the range of 20 to 86 mg KOH/g resin. The same procedure as described in Example 1 was used to prepare these dispersions. The products were stable white dispersions. The characteristics of the resulting dispersion are shown in Table 4A.

TABLE 4A

| | | Mass (g) | | | | | |
|---|---|---|---|---|---|---|---|
| Feed | Component | Run 8 | Run 9 | Run 10 | Run 11 | Run 12 | Run 13 |
| A | Butyl cellosolve | 50.8 | 50.8 | 50.8 | 50.8 | 275.9 | 54.4 |
| A | Deionized water | 7.0 | 7.0 | 7.0 | 7.0 | 76.0 | 12.5 |
| B | Methacrylic acid | 14.00 | 10.19 | 5.93 | 4.91 | 45.64 | 25.50 |
| B | Hydroxypropyl methacrylate | 37.3 | 37.3 | 36.7 | 36.7 | 202.8 | 40.0 |
| B | Ethyl methacrylate | 41.6 | 41.6 | 55.5 | 55.5 | 301.5 | 52.0 |
| B | Styrene | 62.9 | 62.9 | 62.9 | 62.9 | 341.7 | 67.4 |
| B | n-Butyl acrylate | 14.0 | 14.0 | 0.0 | 0.0 | 38.0 | 7.5 |
| B | LUPEROX 26 | 3.58 | 5.36 | 3.35 | 3.35 | 19.41 | 7.76 |
| B | Butyl cellosolve | 9.13 | 9.1 | 9.1 | 9.1 | 49.5 | 9.7 |
| C | Butyl cellosolve | 12.7 | 12.7 | 12.7 | 12.7 | 69.0 | 12.7 |
| C | Deionized water | 16.3 | 16.3 | 16.3 | 16.3 | 50.6 | 16.3 |
| D | LUPEROX 26 | 0.35 | 0.53 | 0.33 | 0.33 | 1.94 | 0.33 |
| E | Dimethylethanolamine | 5.80 | 6.33 | 5.83 | 6.83 | 30.73 | 6.83 |
| E | Deionized water | 19.2 | 19.2 | 19.2 | 19.2 | 104.3 | 19.2 |
| F | BAKELITE PF6535LB | 58.0 | 58.1 | 55.1 | 55.1 | 306.0 | 55.1 |
| F | DUREZ 34285 | 51.0 | 51.1 | 48.4 | 48.4 | 269.1 | 48.4 |
| G | Deionized water | 371.7 | 420.0 | 346.4 | 343.4 | 2,153.1 | 343.4 |

TABLE 4B

| | Run 8 | Run 9 | Run 10 | Run 11 | Run 12 | Run 13 |
|---|---|---|---|---|---|---|
| Solids (wt-%) | 30.2 | 28.7 | 30.2 | 30.1 | 30.7 | 30.7 |
| η (Brookfield; cps) | 205 | 220 | 298 | 175 | 60 | 66 |
| η (#4 Ford cup; sec) | 24.82 | 29.94 | 31.62 | 22.80 | 10.11 | 10.59 |
| AN (mg/KOH/g resin) | 53.7 | 40 | 86 | 32.0 | 24 | 20 |
| pH | 8.7 | 9.6 | 8.0 | 9.4 | 10.1 | 10.6 |
| Mn (Da) | 17,300 | 12,710 | 13,200 | 19,330 | 17,340 | 16,240 |
| Particle size (μm) | 0.10 | 0.12 | 0.11 | 0.16 | 0.36 | 0.83 |

### Example 4. Preparation of Acrylic Dispersion without Phenolic

The Feeds in Table 5A were used in the preparation of acrylic-phenolic dispersion (Run 14). The acrylic polymer was made from acrylic acid, hydroxypropyl methacrylate, ethyl methacrylate, styrene, and n-butyl acrylate. The composition of Run 14 was similar to Run 3 but without phenolic resin. The same procedure was used to prepare the acrylic dispersion as described in Example 1. The product was a stable white dispersion. The characteristics of the resulting dispersion are shown in Table 5B.

TABLE 5A

| | | Mass (g) |
|---|---|---|
| Feed | Component | Run 14 |
| A | Butyl cellosolve | 50.8 |
| A | Deionized water | 7.0 |
| B | Acrylic acid | 1.67 |
| B | Hydroxypropyl methacrylate | 36.7 |
| B | Ethyl methacrylate | 55.5 |
| B | Styrene | 62.9 |
| B | n-Butyl acrylate | 5.6 |
| B | LUPEROX 26 | 3.29 |
| B | Butyl cellosolve | 9.1 |
| C | Butyl cellosolve | 12.7 |
| C | Deionized water | 16.3 |
| D | LUPEROX 26 | 0.33 |
| E | Dimethylethanolamine | 4.13 |
| E | Deionized water | 19.2 |
| F | Deionized water | 234.1 |

TABLE 5B

| | Run 14 |
|---|---|
| Solids (wt-%) | 31.9 |
| η (Brookfield; cps) | 76 |
| η (#4 Ford cup; sec) | 12.28 |
| AN (mg KOH/g resin) | 8.0 |
| pH | 11.0 |
| Mn (Da) | 16,900 |
| Particle size (μm) | 0.21 |

### Example 5. Preparation of Acrylic-Phenolic Dispersion Comprising Methacrylic Acid and Hydroxyethyl Methacrylate

The Feeds in Table 6A were used in the preparation of various acrylic-phenolic dispersions (Runs 15 and 16). The acrylic polymer was made from methacrylic acid, hydroxyethyl methacrylate, ethyl methacrylate, styrene, and n-butyl acrylate. The resultant dispersion comprises two phenolic resins, BAKELITE PF6535 LB and DUREZ 34285. The compositions of Runs 15 and 16 in EXAMPLE 5 were similar to those of Run 3 but hydroxypropyl methacrylate (Run 3) was replaced with hydroxyethyl methacrylate in Feed B. The same procedure described in Example 1 was used to prepare the dispersions. The products were stable white dispersions. The characteristics of the resulting dispersions are shown in Table 6B.

TABLE 6A

Mass (g)

| Feed | Component | Run 15 | Run 16 |
|---|---|---|---|
| A | Butyl cellosolve | 50.8 | 50.8 |
| A | Deionized water | 7.0 | 7.0 |
| B | Methacrylic acid | 8.40 | 8.40 |
| B | Hydroxyethyl methacrylate | 37.3 | 37.3 |
| B | Ethyl methacrylate | 55.5 | 55.5 |
| B | Styrene | 62.9 | 62.9 |
| B | n-Butyl acrylate | 7.0 | 7.0 |
| B | LUPEROX 26 | 3.57 | 3.57 |
| B | Butyl cellosolve | 9.1 | 9.1 |
| C | Butyl cellosolve | 12.7 | 12.7 |
| C | Deionized water | 16.3 | 16.3 |
| D | LUPEROX 26 | 0.35 | 0.35 |
| E | Dimethylethanolamine | 5.66 | 5.22 |
| E | Deionized water | 19.2 | 19.2 |
| F | BAKELITE PF6535LB | 56.4 | 56.4 |
| F | DUREZ 34285 | 49.6 | 49.6 |
| G | Deionized water | 436.8 | 446.8 |

TABLE 6B

| | Run 15 | Run 16 |
|---|---|---|
| Solid (wt-%) | 27.5 | 27.8 |
| η (Brookfield; cps) | 208 | 122 |
| η (#4 Ford cup; sec) | 38.19 | 20.29 |
| AN (mg KOH/g resin) | 32.0 | 32.0 |
| pH | 9.34 | 9.23 |
| Mn (Da) | 18,070 | 20,190 |
| Particle size (μm) | 0.11 | 0.12 |

### Example 6. Preparation of Acrylic-Phenolic Dispersion Comprising Acrylic Acid and Methacrylic Acid

The Feeds in Table 7A were used in the preparation of a acrylic-phenolic dispersion (Run 17). The acrylic polymer was made from acrylic acid, methacrylic acid, hydroxypropyl methacrylate, ethyl methacrylate, styrene, and n-butyl acrylate. The resultant dispersion comprises two phenolic resins, BAKELITE PF6535 LB and DUREZ 34285. The compositions of Run 17 in EXAMPLE 6 were similar to those of Run 3. A combination of acrylic acid and methacrylic acid were used to optimize viscosity and stability. The acid number was 35 mg KOH/g resin. The same procedure as described in Example 1 was used to prepare the dispersion. The product was stable a white dispersion. The characteristics of the resultant dispersion results shown in Table 7B.

TABLE 7A

| | | Mass (g) |
|---|---|---|
| Feed | Component | Run 17 |
| A | Butyl cellosolve | 50.82 |
| A | Deionized water | 7.0 |
| B | Methacrylic acid | 4.19 |
| B | Acrylic acid | 4.19 |
| B | Hydroxypropyl methacrylate | 37.3 |
| B | Ethyl methacrylate | 55.5 |
| B | Styrene | 62.9 |
| B | n-Butyl acrylate | 7.0 |
| B | LUPEROX 26 | 3.53 |
| B | Butyl cellosolve | 9.1 |
| C | Butyl cellosolve | 12.7 |
| C | Deionized water | 16.3 |
| D | LUPEROX 26 | 0.35 |
| E | Dimethylethanolamine | 6.19 |
| E | Deionized water | 19.2 |
| F | BAKELITE PF6535LB | 58.4 |
| F | DUREZ 34285 | 51.4 |
| G | Deionized water | 375.4 |

TABLE 7B

| | Run 17 |
|---|---|
| Solids (wt-%) | 30.8 |
| η (Brookfield; cps) | 186 |
| η (#4 Ford cup; sec) | 36.18 |
| AN (mg KOH/g resin) | 35.0 |
| pH | 9.0 |
| Mn (Da) | 22,780 |
| Particle size (μm) | 0.18 |

### Example 7. Preparation of Acrylic-Cresol Based Phenolic Dispersion Comprising Acrylic Acid

The Feeds in Table 8A were used in the preparation of various acrylic-phenolic dispersions (Runs 18-20). The acrylic polymer was made from acrylic acid, hydroxypropyl methacrylate, ethyl methacrylate, styrene, and n-butyl acrylate. The resultant dispersions comprise one cresol-based phenolic resin, either PHENODUR PR612 or PEHNODUR PR616. The compositions of Run 18 to Run 20 in EXAMPLE 7 were similar to those of EXAMPLE 3. Compared to EXAMPLE 3, in this example BAKELITE PF6535 LB and DUREZ 34285 in Feed G (EXAMPLE 3) were replaced with either PHENODUR PR612 or PHENODUR PR616. The same procedure as described in EXAMPLE 1 was used to prepare these dispersions. The products were stable white dispersions. The characteristics of the resultant dispersion are shown in Table 8B.

TABLE 8A

| | | Mass (g) | | |
|---|---|---|---|---|
| Feed | Component | Run 18 | Run 19 | Run 20 |
| A | Butyl cellosolve | 50.8 | 50.8 | 50.8 |
| A | Deionized water | 7.0 | 7.0 | 7.0 |
| B | Acrylic acid | 7.00 | 7.00 | 7.00 |
| B | Hydroxypropyl methacrylate | 37.3 | 37.3 | 37.3 |
| B | Ethyl methacrylate | 55.5 | 55.5 | 55.5 |
| B | Styrene | 62.9 | 62.9 | 62.9 |
| B | n-Butyl acrylate | 7.0 | 7.0 | 7.0 |
| B | LUPEROX 26 | 3.57 | 3.57 | 3.57 |
| B | Butyl cellosolve | 9.1 | 9.1 | 9.1 |
| C | Butyl cellosolve | 12.7 | 12.7 | 12.7 |
| C | Deionized water | 16.3 | 16.3 | 16.3 |
| D | LUPEROX 26 | 0.35 | 0.35 | 0.35 |
| E | Dimethylethanolamine | 5.62 | 5.62 | 5.62 |
| E | Deionized water | 19.2 | 19.2 | 19.2 |
| F | PHENODUR PR612 | 0 | 89.8 | 70.0 |
| F | PHENODUR PR616 | 86.2 | 0 | 0 |
| G | Deionized water | 348.8 | 395.4 | 395.2 |

TABLE 8B

| | Run 18 | Run 19 | Run 20 |
|---|---|---|---|
| Solids (wt-%) | 29.4 | 29.8 | 28.9 |
| η (Brookfield; cps) | 136 | 125 | 105 |
| η (#4 Ford cup: sec) | 23.38 | 16.37 | 16.85 |
| AN (mg KOH/g resin) | 32.1 | 32.1 | 32.1 |
| pH | 8.8 | 8.9 | 8.9 |
| Mn (Da) | 16,360 | 18,810 | 19,850 |
| Particle size (μm) | 0.12 | 0.12 | 0.10 |

### Example 8. Preparation of Acrylic-Cresol Based Phenolic Dispersion Comprising Methacrylic Acid

The Feeds in Table 9A were used in the preparation of various acrylic-phenolic dispersions (Runs 21-23). The acrylic polymer was made from methacrylic acid, hydroxypropyl methacrylate, ethyl methacrylate, styrene, and n-butyl acrylate. The resultant dispersions comprise one phenolic resin, either PHENODUR PR612 or PHENODUR PR616. The compositions of Runs 21 through 23 in EXAMPLE 8 were similar to those of Run 8. Compared to Run 8, BAKELITE PF6535 LB and DUREZ 34285 were replaced with either PHENODUR PR612 or PHENODUR PR616. The same procedure as described in EXAMPLE 1 was used to prepare the dispersions. The products were stable white dispersions. The resulting characteristics of the dispersions are shown in Table 9B.

TABLE 9A

| | | Mass (g) | | |
|---|---|---|---|---|
| Feed | Component | Run 21 | Run 22 | Run 23 |
| A | Butyl cellosolve | 50.8 | 254.1 | 239.6 |
| A | Deionized water | 7.0 | 35.0 | 33.0 |
| B | Acrylic acid | 7.00 | 42.04 | 39.64 |
| B | Hydroxypropyl methacrylate | 37.3 | 186.8 | 176.2 |
| B | Ethyl methacrylate | 55.5 | 277.7 | 261.8 |
| B | Styrene | 62.9 | 314.7 | 296.7 |
| B | n-Butyl acrylate | 7.0 | 35.0 | 33.0 |
| B | LUPEROX 26 | 3.57 | 17.87 | 16.85 |
| B | Butyl cellosolve | 9.1 | 45.6 | 43.0 |
| C | Butyl cellosolve | 12.7 | 63.6 | 60.0 |
| C | Deionized water | 16.3 | 81.6 | 76.9 |
| D | LUPEROX 26 | 0.35 | 1.78 | 0.84 |
| E | Dimethylethanolamine | 5.62 | 28.30 | 28.74 |
| E | Deionized water | 19.2 | 96.0 | 90.5 |
| F | PHENODUR PR612 | 0.0 | 469.3 | 426.8 |
| F | PHENODUR PR616 | 110.6 | 0.0 | 0.0 |
| G | Deionized water | 374.7 | 1,961.0 | 1,970.7 |

TABLE 9B

| | Run 21 | Run 22 | Run 23 |
|---|---|---|---|
| Solids (wt-%) | 29.7 | 30.7 | 28.2 |
| η (Brookfield; cps) | 95 | 283 | 135 |
| η (#4 Ford cup; sec) | 15.32 | 27.28 | 15.75 |
| AN (mg KOH/g resin) | 32.1 | 32.0 | 32.0 |
| pH | 8.9 | 9.6 | 9.6 |
| Mn (Da) | 16,400 | 18,190 | 15,520 |
| Particle size (μm) | 0.16 | 0.13 | 0.21 |

### Example 9. Preparation of Acrylic Dispersion Comprising Acrylic Acid and Hydroxyethyl Methacrylate

The Feeds in Table 10A were used in the preparation of an acrylic-phenolic dispersion (Run 24). The acrylic polymer was made from acrylic acid, hydroxyethyl methacrylate, ethyl methacrylate, styrene, and n-butyl acrylate. The composition of Run 24 is similar to that of Run 3 but hydroxyethyl methacrylate was used instead of hydroxypropyl methacrylate (Run 3). The same procedure as described in EXAMPLE 1 was used to prepare the acrylic dispersion. The product was a stable white dispersion. The characteristics of the resultant dispersion are shown in Table 10B.

TABLE 10A

| | | Mass (g) |
|---|---|---|
| Feed | Component | Run 24 |
| A | Butyl cellosolve | 50.8 |
| A | Deionized water | 7.0 |
| B | Acrylic acid | 7.00 |
| B | 2-hydroxymethyl methacrylate | 37.3 |
| B | Ethyl methacrylate | 55.5 |
| B | Styrene | 62.9 |
| B | n-Butyl acrylate | 7.0 |
| B | LUPEROX 26 | 3.57 |
| B | Butyl cellosolve | 9.1 |
| C | Butyl cellosolve | 3.7 |
| C | Deionized water | 16.3 |
| D | LUPEROX 26 | 0.35 |
| E | Dimethylethanolamine | 5.62 |
| E | Deionized water | 19.2 |
| F | BAKELITE PF6536LB | 56.0 |
| F | DUREZ 34285 | 49.2 |
| G | Deionized water | 392.7 |

TABLE 10B

| | Run 25 |
|---|---|
| Solids (wt-%) | 29.3 |
| η (Brookfield; cps) | 132 |
| η (#4 Ford cup; sec) | 19.08 |
| AN (mg KOH/g resin) | 9.34 |
| pH | 32.0 |
| Mn (Da) | 16,650 |
| Particle size (μm) | 0.12 |

### Test Methods

### Acid Number (AN) of Acrylic Resin

The acid number was calculated as the product of the wt-% of the total of the acid functional monomers (e.g., (meth)acrylic acid) in the total acrylic resin and the quotient of 56100 and the molecular weight of the (meth)acrylic acid (e.g., AN=(wt-% (meth)acrylic acid monomer×(56100/(molecular weight (meth)acrylic acid monomer)). An acid, including an organic acid and/or inorganic acid, can be calculated based on the equation (molecular weight of the acid, weight percentage of the acid in the formulation should be known).

In a different method, the acid numbers of resins may be measured using a titration method with 0.1 N KOH in methanol and phenolphthalein indicator. Based on the amount of KOH consumed, the acid number is calculated and reported as mg KOH per 1 gram of dry resin.

For example, a sample (around 1.0 g) is weighted on an analytical balance and then transferred on a 100-mL beaker. The sample is dissolved in 25 mL of mixture of methyl ethyl ketone and dimethyl formamide (1:1) containing thymol blue indicator. The solution is titrated with the 0.1 N methanolic potassium hydroxide solution. The resulting acid number is expressed in units of mg KOH/g and calculated using the following equation: Acid number=titre value of KOH solution×Normality KOH solution (0.1 N)×56.1/[weight of the sample (g)*solid content of the sample (%)], mg KOH/g.

### Hydroxyl Number of Acrylic Resin

The hydroxyl number was calculated as the product of the wt-% of the hydroxyl functional acrylate monomer in the total acrylic resin and the quotient of 56100 and the molecular weight of the hydroxyl functional (meth)acrylate monomer (e.g., Hydroxyl Number=(wt-% hydroxyl functional (meth)acrylate monomer×(56100/(molecular weight of hydroxyl functional (meth)acrylate monomer.

### Panel Coating

An 8×8″ tin plate panel (typically, tin coated on steel) with thickness 0.0083 inches (0.0208 mm) was placed on the glass surface of the drawdown plate. A coating liquid (2-3 g) from sample Run 1 using a disposable transfer pipet was placed near the top of the tin plate sheet. A Mayer drawdown rod (#22) was placed on the top of the tin plate and moved the coating liquid from the top to bottom to form a liquid film on the tin plate having a coating weight of 4-5 mg/in². The coated tin plate was baked in oven at 425 °F for 3.5 minutes. All of the test samples were prepared by the same process.

### Adhesion Test

The Adhesion test was conducted according to ASTM D3359-17 using SCOTCH 610 tape available from 3M (Saint Paul, MN). Briefly, a baked tin plate was cross hatched with a metal scribe by making 4 parallel lines and intersecting them at approximately 90 degrees with 4 additional lines. A strip of 3M SCOTCH tape approximately three inches long was pressed diagonally across the scribed squares. The tape was pressed down firmly with the finger. The tape was then removed from the tin plate. The removal of the tape was a peeling back with a quick pull. Adhesion is generally rated on a scale of 0B to 5B where the scale is based on the percent of the area originally coated with the sample that showed evidence of coating flaking and/or coating removal. Ratings of 5B, 4B, 3B, 2B, 1B, and 0B indicate that 0%, less than 5%, 5%-15%, 15%-35%, 35%-65%, and greater than 65%, respectively, of the area originally coated showed evidence of coating flaking and/or coating removal after completion of the test. Preferably, an adhesion rating of at least 4B (i.e., 4B or 5B) is considered to be adherent. See data in Table 11

### Solvent Resistance Test (MEK Double Rubs)

The extent of “cure” or crosslinking of a coating was measured as a resistance to solvents, such as methyl ethyl ketone (MEK). This test was performed as described in ASTM D 5402-93. The round tip of a 2 lb. ball peen hammer was covered by attaching a felt pad square. The pad was saturated with MEK. The saturated pad covered tip of hammer was placed on the coated surface of the baked tin plate. The hammer was guided in a 3-4 inch back-and-forth path across the surface. After 75 times of the back-and-forth cycle continued with the saturated pad, coating breakthrough occurs.

The number of double-rubs (i.e., one back-and-forth motion) was reported. Preferably, the MEK solvent resistance was at least 30 double rubs (DR). Generally, high MEK double rubs indicated high crosslink density which generally corresponded to good solvent (e.g., chemical) resistance. For example, coating films for food cans should be highly crosslinked (at least 30 double rubs, usually at least 50 double rubs) because many food substances cause corrosion. Coating film for beverage cans may have lower MEK double rubs, such as, 30 double rubs or lower. The number of double rubs (i.e., one back-and-forth motion) at which failure was reached was reported. The results are shown in Table 11. The back-and-forth cycle on some of test samples was 100 times. All of the test samples from 75-100 times of MEK double rubs showed good solvent resistance.

### Reverse Impact Test

The reverse impact test measures the coated substrate's ability to withstand the deformation encountered when impacted by steel with a hemispherical head. The test was performed as described in ASTM D2794-93. Briefly, a baked tin plate was placed over the socket die of BYK Gardner OVERBALL Impact Tester instrument with the coated side down for reverse impact. The panel was held in place by hand. A one pound (0.45 kg) standard metal rod in a cylinder was dropped from a height of 36 inches (91.4 cm) onto the baked tin plate. Following the test, the coating was visually inspected for micro-cracking or microfracture-commonly referred to as crazing. Test pieces were impacted on the uncoated or reversed side. The crazing of the coating was determined via visual assessment. The film was examined for any sign of micro-crazing or crazing with particular attention paid to on stressed/formed areas. A sample failed if crazing or cracks were observed. A sample passed if no crazing or cracks were observed. The results for various films made in the Examples are shown in Table 11.

### Pack Test: Coating D&I Cans Using Spray Application

One of the potential uses of the coating compositions of the present disclosure is as a waterborne spray coating for the interior of tin plate drawn and ironed (D&I) food cans with the commercial dimensions identified as ‘300×407’. This indicates a commercial can size having a height of 0.113 m and a diameter of 0.076 m. This yields a can having an internal area of 0.032 m².

To facilitate spray-application of the coating compositions to the interior of commercially available tin plate D&I cans, the viscosity of each coating was adjusted such that the flow rate of each coating through a Ford viscosity cup (#4 orifice) was in the range of 16 to 30 seconds at 25 °C. The application of each coating was conducted using a laboratory-scale D&I spray unit commercially available form H.L. Fisher Co (Ronks, PA).

A sufficient amount of wet coating was delivered to the interior of the D&I cans to yield a total cured film weight of 300 mg per can. The cans were thermally cured using a laboratory-scale D&I can oven commercially available from Midland Ross Co., New Brunswick, NJ. The controls on the oven were programmed to deliver a thermal dosage that is consistent with thermal dosages employed in the preparation of commercially coating coated tin plate D&I cans. The residence time of each can within the oven was approximately 5.5 minutes. Each can achieved a maximum temperature of approximately 221 °C. Cans were baked at a minimum temperature of 213 °C for approximately 2.0 minutes.

### Global Extraction

The global extraction test may be used to estimate the total amount of mobile material that can potentially migrate out of a coating and into food packed in a coated can. Typically, a coated substrate is subjected to water or a solvent blend under a variety of conditions to simulate a given end-use.

Acceptable extraction conditions and media can be found in 21 CFR § 175.300, paragraphs (d) and (e). The extraction procedure used in the current disclosure may be conducted in accordance with the Food and Drug Administration (FDA) “Preparation of Premarket Submission for Food Contact Substances: Chemistry Recommendations,” (December 2007). The allowable global extraction limit as defined by the FDA regulation is 50 parts per million (ppm).

Preferred coatings give global extraction results of less than 50 ppm, less than 25 ppm, less than 10 ppm, or less than 1 ppm extractables. Most preferably, the global extraction results are optimally non-detectable.

Total Resin Solids (when No Inorganic Material is Present)

The theoretical resin solid content can be calculated and/or the experimental total solid resin content can be determined. Unless otherwise specified, the total resin solids of the present disclosure are experimentally determined using the following method. The total resin solids test was used to measure the wt-% of total resin solids in the compositions. A coating composition was deposited into a vessel and the vessel was massed. The vessel containing the composition was subjected to a temperature of 400 °F (204.4 °C) for 5 minutes and then massed. The wt-% total resin solids is calculated as:

$$\frac{mass after heating}{mass before heating} \times 100$$

### Stability

To test the stability of the liquid coating compositions of the present disclosure, a sealed container (e.g., glass jar) that includes the liquid coating composition was stored at ambient temperature for 6 months (not in direct sunlight such as occurs with storage in a cabinet). Following 6 months, the coating composition were observed by the unaided human eye for phase separation.

### Viscosity (η)

Viscosity was tested via ASTM D1200-10 and ASTM D2196-20.

ASTM 1200-10 is used to determine the viscosity of Newtonian or near-Newtonian materials. In the present examples, for viscosity, a Ford cup #4 was used. Briefly, a viscosity cup with a blocked orifice was filled with the sample. The blocking mechanism was removed allowing efflux of the sample through the orifice. The duration in seconds, from the time the blocking mechanism was removed to the first break in the stream, was reported.

ASTM D2196-20 is used to determine the apparent viscosity of non-Newtonian materials. A Brookfield Viscometer DV2T (Brookfield Engineering Laboratories, Middleboro, MA) was used to determine the apparent viscosity using Test Method A of ASTM D2196-20.

### Particle Size

The particle sizes of the acrylic-PF dispersion were measured using laser diffraction and polarization intensity differential scattering (PIDS) technology. Specifically, the particle sizes were measure using a Coulter Particle Size LS 13 320 with Universal Liquid Module (Beckman Coulter, Indianapolis, IN.

### Test Results

TABLE 11

| | | MEK | |
|---|---|---|---|
| Sample** | Adhesion | Double Rubs | Reverse Impact |
| *Control | 4B | 100 | No crazing (pass) |
| Run 1 | 5B | 75 | Crazing (fail) |
| Run 3 | 5B | 75 | Crazing (fail) |
| Run 4 | 5B | 100 | Crazing (fail) |
| Run 5 | 5B | 100 | Crazing (fail) |
| Run 15 | 5B | 75 | No crazing (pass) |
| Run 17 | 5B | 100 | No crazing (pass) |
| Run 18 | 5B | 75 | Crazing (fail) |
| Run 20 | 5B | 75 | Crazing (fail) |
| Run 21 | 5B | 75 | No crazing (pass) |
| Run 23 | 5B | 75 | Crazing (fail) |
| Run 24 | 5B | 100 | No crazing (pass) |

*The control is BPA-acrylic with phenolic crosslinker
**These are representative results for runs that had greater than 6 months stability.

### Results of Pack Test

Pack test including an acidic sauce and a green vegetable for the cured cans was conducted at 120 °F (48.89 °C) for 2 weeks. In addition to adhesion, the coatings were evaluated for both corrosion and stain using a visual rating scale of 0 to 10 with 10 being the best (10=no signs of corrosion or stain; 9=0%<surface area of corrosion or stain <1%; 7=1%<surface area of corrosion or stain <10%; 5=10%<surface area of corrosion or stain <25%; 3=25%<surface area of corrosion or stain <50%; 0=50%<surface area of corrosion or stain). The results of the testing are seen in Table 12.

TABLE 12

| | | |
|---|---|---|
| | | Example 3, |
| Sample | *Control | Run 12 |

Acidic Food Sauce

| | | |
|---|---|---|
| Corrosion | 9.1 | 9.3 |
| Stain | 10 | 10 |
| Adhesion | 5B | 5B |

Green Vegetable

| | | |
|---|---|---|
| Corrosion | 9.5 | 9.3 |
| Stain | 10 | 10 |
| Adhesion | 5 B | 5B |

*Control - epoxy-acrylic coating

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. An aqueous food or beverage container coating composition comprising:
at least 50 wt-%, based on total resin solids, of an at least partially neutralized acid- or anhydride-functional organic-solution polymerized acrylic polymer, wherein:
the acrylic polymer is hydroxyl-functional;
the acrylic polymer has a calculated acid number of less than 60 mg KOH per gram resin; and
the acrylic polymer is self-dispersible in water;
a phenolic crosslinker; and
an aqueous liquid carrier;
wherein the coating composition is storage stable for at least 2 months at ambient temperature, not in direct sunlight, without any phase separation as determined by the unaided human eye.

2. (canceled)

3. The aqueous food or beverage container coating composition of claim 1 comprising at least 1 wt-% of the phenolic crosslinker, based on total resin solids.

4. The aqueous food or beverage container coating composition of claim comprising
at least 5 wt-% of the phenolic crosslinker, based on total resin solids.

5. The aqueous food or beverage container coating composition of claim 1 comprising:
at least 50 wt-%, based on total resin solids, of an acrylic polymer prepared from two or more at least partially neutralized acid- or anhydride-functional organic-solution polymerized acrylic prepolymers, wherein:
at least one prepolymer is hydroxyl-functional;
each of the two or more prepolymers has a calculated acid number of less than 60 mg KOH per gram resin; and
each of the two or more prepolymers is self-dispersible in water.

6. The aqueous food or beverage container coating composition of claim 5 comprising at least 1 wt-% of the phenolic crosslinker, based on total resin solids.

7. The aqueous food or beverage container coating composition of claim 6 comprising
at least 5 wt-% of the phenolic crosslinker, based on total resin solids.

8. The aqueous food or beverage container coating composition of claim 1 comprising:
at least 20 wt-% of the phenolic crosslinker, based on total resin solids;
wherein the coating composition includes 20 wt-% to 40 wt-% of total solids, based on the total weight of the composition.

9. The aqueous food or beverage container coating composition of claim 1 comprising up to 50 wt-% of the phenolic crosslinker, based on total resin solids.

10. The aqueous food or beverage container coating composition of claim 1, which is storage stable for at least 6 months, at ambient temperature, not in direct sunlight, without any phase separation as determined by the unaided human eye.

11. The aqueous food or beverage container coating composition of claim 1 comprising up to 99 wt-% of the acrylic polymer, based on total resin solids.

12. The aqueous food or beverage container coating composition of claim 1, wherein the acrylic polymer comprises interpolymerized acid-functional monomers.

13. The aqueous food or beverage container coating composition of claim 1, wherein when applied on a tin plate panel having a thickness of 0.0208 mm in an amount sufficient to achieve a dry film weight of 4-5 mg/in², after exposure to a temperature of 425 °F (218 °C) for 3.5 minutes, provides a cured coating having one or more of the following properties:
an adhesion rating of at least 4B when tested pursuant to the Adhesion Test in the Test Methods;
a double rub rating of at least 50 when tested pursuant to the Solvent Resistance Test in the Test Methods; or
displaying no crazing when tested pursuant to the Reverse Impact Test in the Test Methods.

14. A coated metal substrate comprising a metal substrate having a cured adherent coating disposed on at least a portion of a surface thereof, wherein the coating is formed from an aqueous food or beverage container coating composition claim 1.

15. A coated metal substrate comprising a metal substrate having a cured adherent coating disposed on at least a portion of a surface thereof, wherein the coating is formed from an aqueous food container coating composition comprising:
at least 50 wt-%, based on total resin solids, of an at least partially neutralized acid- or anhydride-functional organic-solution polymerized acrylic polymer, wherein:
the acrylic polymer is hydroxyl-functional;
the acrylic polymer has a calculated acid number of less than 60 mg KOH per gram resin; and
the acrylic polymer is self-dispersible in water;
at least 20 wt-% of crosslinker including one or more phenolic crosslinkers, based on total resin solids; and
an aqueous liquid carrier.

16. A metal packaging comprising a coated metal substrate of claim 14.

17. A method of forming an aqueous food or beverage coating composition of claim 1, the method comprising:
providing a first mixture comprising an ethylenically unsaturated monomer component and an organic solvent;
polymerizing the ethylenically unsaturated monomer component in the organic solvent to form a polymer mixture and an acid- or anhydride functional polymer, the acid- or anhydride-functional acrylic polymer having a calculated acid number of less than 60 mg KOH per gram polymer;
adding a fugitive base to the polymer mixture to at least partially neutralize the acid- or anhydride-functional acrylic polymer to from an at least partially neutralized acid- or anhydride-functional acrylic polymer and a second mixture, the second mixture comprising the at least partially neutralized acid- or anhydride-functional acrylic polymer; and
combining the second mixture with water to form an aqueous coating composition that includes (i) at least 50 wt-%, based on total resin solids, of the acrylic polymer and (ii) at least 5 wt-%, based on total resin solids, of a phenolic crosslinker;
wherein the aqueous coating composition is storage stable for at least 2 months at ambient temperature, not in direct sunlight, without any phase separation as determined by the unaided human eye.

18. The method of claim 17, wherein the first mixture comprises the phenolic crosslinker.

19. The method of claim 17, further comprising adding a phenolic crosslinker to the second mixture.

20. A method of coating a food or beverage container, the method comprising:
providing a food or beverage container coating composition of claim 1;
causing the coating composition to be applied to at least a portion of a metal substrate prior to or after forming the metal substrate into a food or beverage container or portion thereof; and
thermally curing the coating composition to form a cured coating.

21. An at least partially neutralized acid- or anhydride-functional organic-solution polymerized acrylic polymer comprising interpolymerized monomers comprising (meth)acrylic acid; wherein the acrylic polymer is hydroxyl-functional, has a calculated acid number of less than 60 mg KOH per gram resin, is self-dispersible in water, and is crosslinked with at least 5 wt-% resole phenolic crosslinker, based on total resin solids.

22. (canceled)

23. (canceled)
